(19) United States
(12) Patent Application Publication
(10) Pub. No.: US 2025/0357762 A1
(43) Pub. Date: Nov. 20, 2025

(54) MODULAR POWER ARCHITECTURE

(71) Applicant: STORMENTUM, INC., Austin, TX (US)

(72) Inventor: Patrick Chapman, Austin, TX (US)

(73) Assignee: STORMENTUM, INC., Austin, TX (US)

(21) Appl. No.: 19/201,290

(22) Filed: May 7, 2025

Related U.S. Application Data
(60) Provisional application No. 63/649,175, filed on May 17, 2024.
(60) Provisional application No. 63/689,867, filed on Sep. 3, 2024.
(60) Provisional application No. 63/712,501, filed on Oct. 27, 2024.
(60) Provisional application No. 63/721,481, filed on Nov. 16, 2024.

(51) Int. Cl. H02J 3/38; H02M 3/00

(52) U.S. Cl. CPC H02J 3/381; H02M 3/003; H02J 2203/10; H02J 2300/26

(57) ABSTRACT

Apparatus and associated methods relate to a modular energy conversion system (MECS). In an illustrative example, the MECS may include a distributed power converter having a first and second subsets of hybrid converter modules (HCMs). For example, output ports of the first subset of HCMs may be electrically connected in series to form an upper arm, and the output ports of the second subset of HCMs may be electrically connected in series to form a lower arm. The upper and lower arms may be electrically connected at a first end to form a connection point. A unipolar voltage source may be electrically connected to an opposite end of the connection point of the upper and lower arms. A power combiner unit (PCU) may be physically separated from and electrically connected to the connection point. For example, the PCU may be configured to measure electrical property at the connection point and adaptively regulate AC power generated at the connection point based on the measured electrical property. Various embodiments may advantageously enable efficient integration of distributed renewable energy sources and energy storage while providing power scaling through a modular architecture.

### CROSS-REFERENCES TO RELATED APPLICATIONS

This application claims the benefit of the following U.S. Provisional Applications:
U.S. Provisional Application Ser. No. 63/649,175, titled “Power Converter for Energy System Control and Optimization,” filed by Patrick Chapman on May 17, 2024;
U.S. Provisional Application Ser. No. 63/689,867, titled “Modular Energy Conversion System,” filed by Patrick Chapman on Sep. 3, 2024;
U.S. Provisional Application Ser. No. 63/712,501, titled “Modular Energy Conversion System,” filed by Patrick Chapman on Oct. 27, 2024; and
U.S. Provisional Application Ser. No. 63/721,481, titled “Modular Energy Conversion Systems and Controls,” filed by Patrick Chapman on Nov. 16, 2024.

This application incorporates the entire contents of the foregoing applications herein by reference.

### TECHNICAL FIELD

Various embodiments relate generally to modular energy conversion systems applicable to a power system of, for example, converting renewable energy to a main power grid.

### BACKGROUND

The demand for renewable energy has grown significantly in recent years. For example, for sustainability purposes, public in general seeks to reduce reliance on fossil fuels and lower carbon emissions. Among the various renewable sources available today, for example, solar energy may have emerged as one of the most accessible and widely adopted technologies for both residential and commercial use. The falling cost of solar panels, along with policy incentives, has made it increasingly viable for households to install rooftop solar systems.

Residential solar systems may allow homeowners to generate electricity from sunlight and use that power to meet everyday energy needs, for example. Common applications include powering household appliances, heating water, and charging electric vehicles (EVs). In addition to reducing electricity bills, such systems offer a measure of energy independence and resilience during grid outages when combined with energy storage.

When a solar power system produces more energy than the home immediately consumes, in some cases, excess power may be exported back to a utility grid. This arrangement, for example, may be supported through net metering or other grid-sharing policies. For example, homeowners may then receive credits or compensation for the energy they supply. For example, some net export may help stabilize the broader energy infrastructure, particularly during times of peak demand.

### SUMMARY

Apparatus and associated methods relate to a modular energy conversion system. In an illustrative example, the modular energy conversion system may include a distributed power converter that includes a first and second subsets of hybrid converter modules (HCMs). Each HCM may have an input port to receive power from an external source and an output port. The output ports of the first subset of HCMs may be electrically connected in series to form an upper arm, and the output ports of the second subset of HCMs may be electrically connected in series to form a lower arm. The upper and lower arms may be electrically connected at a first end to form a connection point. A unipolar voltage source may be electrically connected to an opposite end of the connection point of the upper and lower arms. A power combiner unit (PCU) may be physically separated from and electrically connected to the connection point. For example, the PCU may be configured to measure electrical property at the connection point and adaptively regulate AC power generated at the connection point based on the measured electrical property. Various embodiments may advantageously enable efficient integration of distributed renewable energy sources and energy storage while providing power scaling through a modular architecture.

Various embodiments may achieve one or more advantages. For example, some embodiments may advantageously enable efficient integration of distributed renewable energy sources with energy storage systems. Some embodiments may advantageously provide flexible voltage and power scaling through a modular architecture. Some embodiments may, for example, advantageously allow independent maximum power point tracking for individual solar panels. Some embodiments may advantageously reduce overall system cost. For example, some embodiments may advantageously improve system reliability through distributed power conversion. Some implementations, for example, may advantageously simplify installation with standardized components.

The details of various embodiments are set forth in the accompanying drawings and the description below. Other features and advantages will be apparent from the description and drawings, and from the claims.

### BRIEF DESCRIPTION OF THE DRAWINGS

FIG. 1 illustrates a block diagram of an exemplary modular energy conversion system connected to a residential building.

FIG. 2 illustrates a block diagram of an exemplary modular power conversion system with two hybrid converter legs.

FIG. 3 illustrates a block diagram of an exemplary modular power conversion system with one hybrid converter leg.

FIG. 4 illustrates another block diagram of an exemplary modular power conversion system.

FIG. 5 illustrates a block diagram of an exemplary hybrid converter array with multiple hybrid converter arms.

FIG. 6 illustrates a block diagram of an exemplary modular power conversion system configured to generate a three phase alternating current (AC) load.

FIG. 7 illustrates a block diagram of an exemplary modular energy conversion system with hybrid converter modules.

FIG. 8 illustrates a flowchart of an exemplary method for operating a modular energy conversion system.

FIG. 9 illustrates a flowchart of an exemplary method for configuring hybrid converter modules.

FIG. 10 illustrates a flowchart of an exemplary solar power control process.

FIG. 11 illustrates a flowchart of an exemplary process for synchronizing hybrid converter module outputs.

FIG. 12 illustrates a block diagram of an exemplary hub and battery system for energy conversion.

FIG. 13 illustrates a circuit diagram of an exemplary solar branch circuit with multiple circuit blocks.

FIG. 14 illustrates a circuit diagram of an exemplary modular energy conversion system with a hybrid converter module.

FIG. 15 illustrates a block diagram of an exemplary modular energy conversion system with rooftop and ground-level components.

FIG. 16 illustrates a block diagram of an exemplary modular energy conversion system with a hybrid converter array.

FIG. 17 illustrates a block diagram of an exemplary hybrid converter system interfacing with a solar panel.

FIG. 18 illustrates a circuit diagram of an exemplary power combiner unit with multiple terminal connections.

FIG. 19 illustrates a block diagram of an exemplary modular energy conversion system with hybrid converter modules.

FIG. 20 illustrates a circuit diagram of an exemplary power combiner unit with multiple terminal connections.

FIG. 21 illustrates another circuit diagram of an exemplary power combiner unit with control components.

FIG. 22 illustrates circuit diagrams of exemplary operating states of a hybrid converter unit.

FIG. 23 illustrates a circuit diagram of an exemplary hybrid converter unit with multiple switching cells.

FIG. 24 illustrates circuit diagrams of exemplary variations of a solar-enabled hybrid converter unit.

FIG. 25 illustrates a circuit diagram of an exemplary solar-enabled hybrid converter unit with a microcontroller.

FIG. 26 illustrates another circuit diagram of an exemplary solar-enabled hybrid converter unit.

FIG. 27 illustrates a circuit diagram of an exemplary power combiner unit with EVSE signals.

FIG. 28 illustrates a circuit diagram of an exemplary hybrid converter unit with a junction box.

FIG. 29 illustrates a circuit diagram of an exemplary solar-enabled hybrid converter unit with switching elements.

FIG. 30 illustrates another circuit diagram of an exemplary solar-enabled hybrid converter unit with multiple switches.

FIG. 31 illustrates a block diagram of an exemplary modular energy conversion system with various components.

FIG. 32 illustrates a block diagram of an exemplary hybrid converter module with power conversion stages.

FIG. 33 illustrates a block diagram of an exemplary power combiner unit with control and protection components.

FIG. 34 illustrates a block diagram of an exemplary modular energy conversion system with upper and lower arms.

FIG. 35 illustrates a block diagram of an exemplary output current control system.

FIG. 36 illustrates another block diagram of an exemplary control system for power conversion.

FIG. 37 illustrates a block diagram of an exemplary three-phase control system for power conversion.

FIG. 38 illustrates a block diagram of an exemplary control system with multiple signal processing blocks.

FIG. 39 illustrates a block diagram of an exemplary control system for regulating output voltage and current.

FIG. 40 illustrates a block diagram of an exemplary control system for processing signals in power conversion.

FIG. 41 illustrates a block diagram of an exemplary control system for regulating power conversion in a modular energy system.

FIG. 42 illustrates a block diagram of an exemplary control system for maximum power point tracking.

FIG. 43 illustrates a block diagram of an exemplary power conversion system for residential applications.

FIG. 44 illustrates a flowchart of an exemplary process for measuring and adjusting voltages in a hybrid converter module system.

FIG. 45 illustrates exemplary sample waveforms of voltage traces in a modular energy conversion system.

FIG. 46 illustrates additional exemplary sample waveforms of voltage traces in a modular energy conversion system.

FIG. 47 illustrates exemplary sample waveforms of current and voltage measurements in a modular energy conversion system.

FIG. 48 illustrates exemplary sample waveforms of multiple electrical parameters in a modular energy conversion system.

FIG. 49 illustrates an exemplary stair-step voltage waveform in a modular energy conversion system.

FIG. 50 illustrates exemplary sample waveforms of voltage and current in a modular energy conversion system.

FIG. 51 illustrates exemplary sample waveforms of multiple electrical parameters in a modular energy conversion system.

FIG. 52 illustrates exemplary sample waveforms of voltage measurements in a modular energy conversion system.

FIG. 53 illustrates exemplary sample waveforms of current and voltage in a modular energy conversion system.

Like reference symbols in the various drawings indicate like elements.

### DETAILED DESCRIPTION OF ILLUSTRATIVE EMBODIMENTS

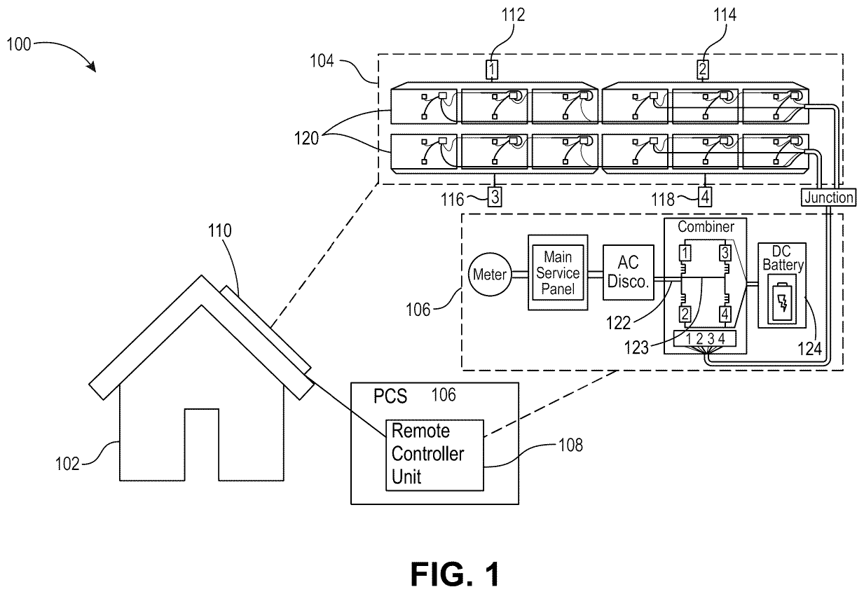

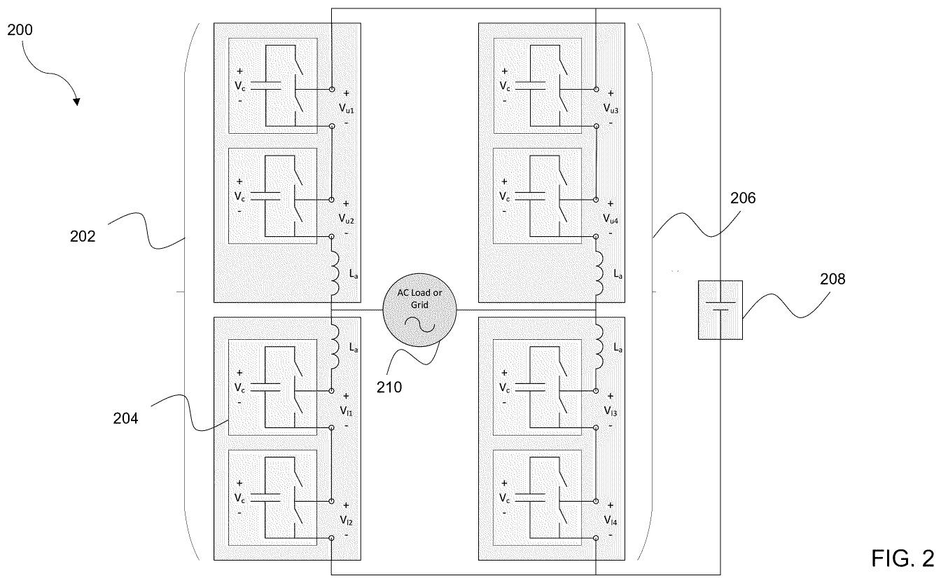

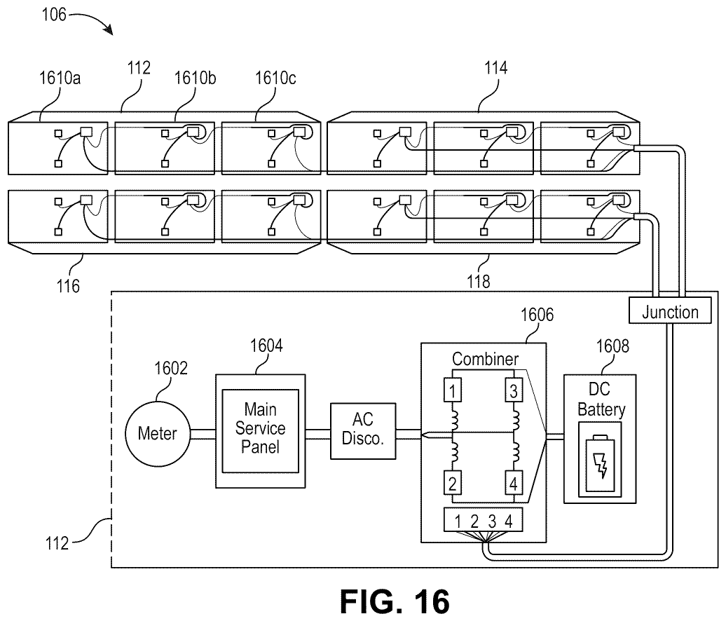

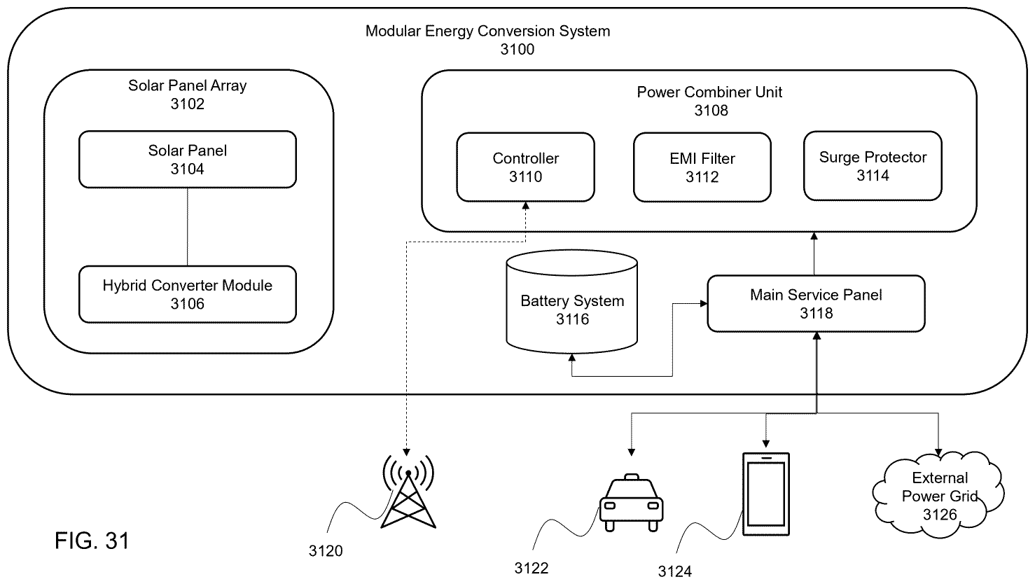

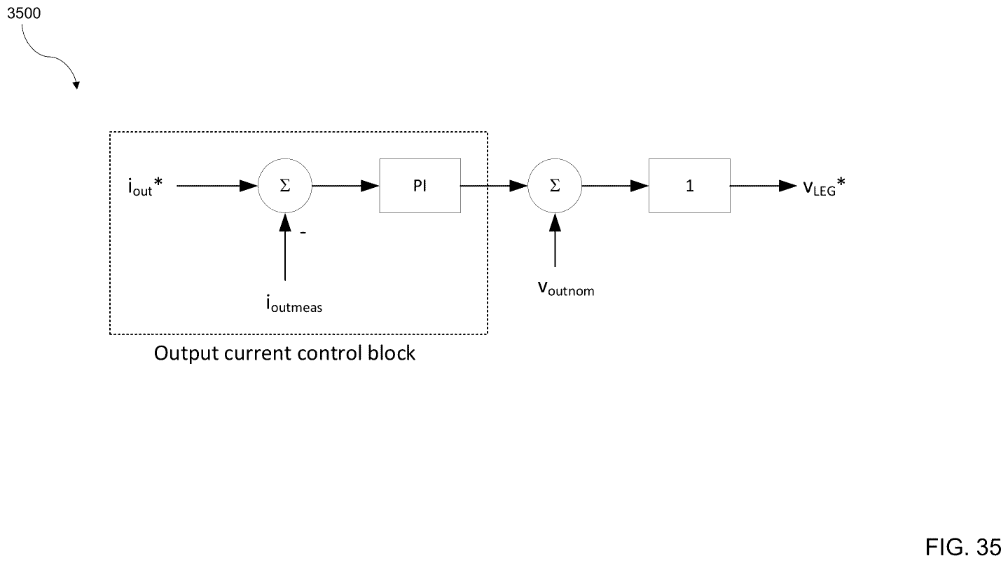

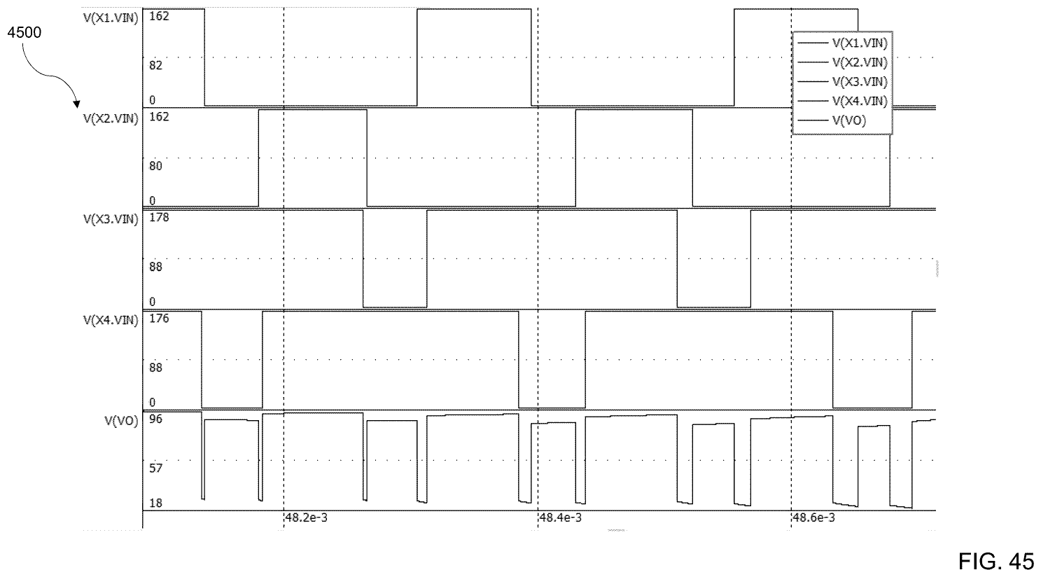

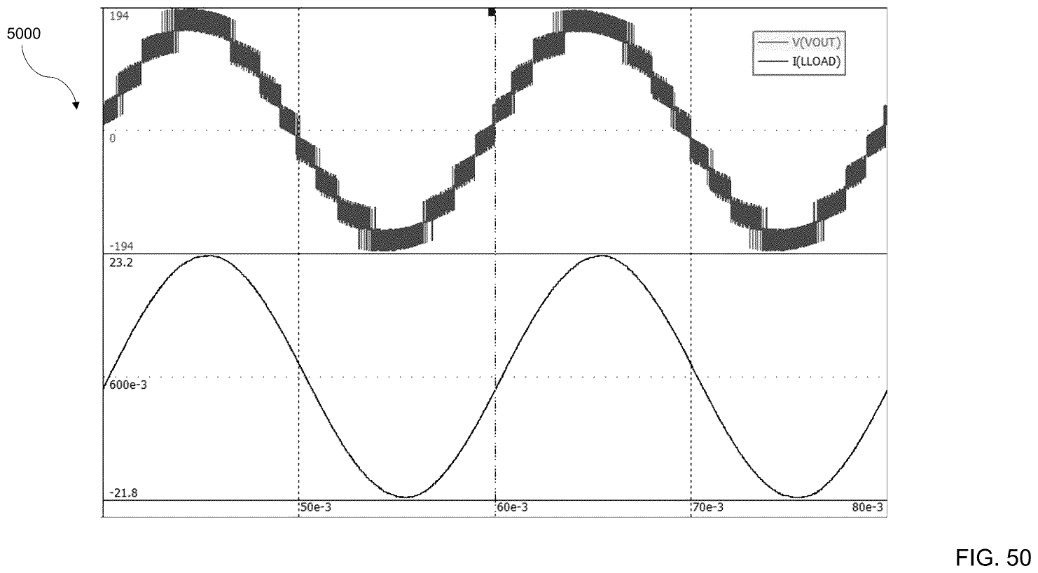

To aid understanding, this document is organized as follows. First, to help introduce discussion of various embodiments, a modular energy conversion system is introduced with reference to FIGS. 1-15. Second, that introduction leads into a description with reference to FIGS. 16-30 of some exemplary embodiments of hybrid converter modules and power combiner units. Third, with reference to FIGS. 31-34, the modular energy conversion system is described in application to exemplary residential and commercial power systems. Fourth, with reference to FIGS. 2-49 the discussion turns to exemplary embodiments that illustrate control systems and methods for the modular energy conversion system. Fifth, and with reference to FIGS. 35-44, this document describes exemplary apparatus and methods useful for voltage regulation and synchronization. Sixth, this disclosure turns to a review of experimental data and a discussion of performance characteristics. One topology is reviewed with reference to FIGS. 45-49. A second exemplary embodiment with multiple hybrid converter arms is reviewed with reference to FIGS. 50-53. Finally, the document discusses further embodiments, exemplary applications and aspects relating to scalability, reliability, and efficiency improvements.

In some examples, the modular energy conversion system may present an approach to integrating distributed renewable energy sources and energy storage systems. It may address the challenges of power conversion and grid integration by utilizing a distributed architecture of hybrid converter modules (HCMs) coordinated through a physically separated power combiner unit (PCU). A feature of the system may lie in the utilization of series-connected configuration of HCMs forming upper and lower arms, combined with adaptive regulation of AC power at the connection point. This approach may be distinguished from existing solutions by enabling flexible voltage and power scaling while maintaining independent control of individual energy sources.

FIG. 1 illustrates a block diagram of an exemplary modular energy conversion system (MECS 100) connected to a residential building 102. As shown, the MECS 100 includes a roof top generation module (RTGM 104) operably coupled to a power combiner system 106. For example, the power combiner system 106 may be physically separated from and interfacing with the RTGM 104. As shown, the power combiner system 106 includes a remote controller unit (RCU 108). For example, the RTGM 104 may process (e.g., renewable) energy received to generate an output power. For example, the RTGM 104 may include one or more solar panels 110 coupled to an array of converters (e.g., DC-DC converters, hybrid converters).

As shown, the RCU 108 includes a power combiner unit 104. For example, the power combiner unit 104 may combine power generated from the RTGM 104 to generate an AC output power. For example, the power combiner unit 106 may receive multiple DC signals from the RTGM 104 to synthesize a time-aligned AC waveform for delivery to the residential building 102. In some implementations, the power combiner system 106 may generate the AC output to supply power to a utility grid.

As shown, the RTGM 104 includes a first hybrid converter arm 112, a second hybrid converter arm 114, a third hybrid converter arm 116, and a fourth hybrid converter arm 118. Each of the first hybrid converter arm 112, the second hybrid converter arm 114, the third hybrid converter arm 116, and the fourth hybrid converter arm 118 includes multiple hybrid converter units 120. For example, the multiple hybrid converter units 120 may include a direct current (DC)-DC converter. For example, the multiple hybrid converter units 120 may include a hybrid converter circuit configured to perform power conversion and/or synchronization functions.

In some embodiments, each of the hybrid converter units 120 may include control electronics to independently regulate output voltage and current, perform maximum power point tracking (MPPT), and coordinate switching operations to support modular multilevel power generation. In some examples, the multiple hybrid converter units 120 may be distributedly disposed across a rooftop of the residential building 102. In some implementations, each of the multiple hybrid converter units 120 may be configured to process power from an external source, such as a solar panel and/or energy storage device. For example, the multiple hybrid converter units 120 may collectively operate to receive power from the one or more solar panels 110 and generate an AC waveform when combined through the power combiner system 106.

In this example, the multiple hybrid converter units 120 of the first hybrid converter arm 112, the second hybrid converter arm 114, the third hybrid converter arm 116, and the fourth hybrid converter arm 118 are connected in series within each corresponding hybrid converter arm. For example, the series connection of the multiple hybrid converter units 120 may advantageously allow voltage addition and flexible power scaling.

As shown, the first hybrid converter arm 112 and the second hybrid converter arm 114, and the third hybrid converter arm 116 and the fourth hybrid converter arm 118 forms a first and a second hybrid converter leg, respectively. In some examples, the hybrid converter arms (112, 114, 116, 118) may be arranged in pairs, with the first hybrid converter arm 112 and second hybrid converter arm 114 forming one leg, and the third hybrid converter arm 116 and fourth hybrid converter arm 118 forming another leg. This configuration may advantageously allow for balanced power processing and increased system reliability through redundancy. In some examples, multiple hybrid converter legs may advantageously supply multi-phase (e.g. 3 phase, 6 phase) AC power output.

The first hybrid converter arm 112 and the second hybrid converter arm 114 connect at a common connection point 122, and the third hybrid converter arm 116 and the fourth hybrid converter arm 118 connect a different common connection point 123. These connection points may be configured to connect any combination of hybrid converter arms, allowing for flexible and adaptable arm configurations. The number and arrangement of connection points are not limited to any specific configuration and may vary based on the intended application, power requirements, or system design specifications. In this example, the power combiner system 106 includes a battery 124. For example, the battery 124 may generate a unipolar voltage. The battery 124 is connected in parallel to the first hybrid converter leg and the second hybrid converter leg. Various embodiments for connecting the battery 124 to the first hybrid converter leg and the second hybrid converter leg are further described in detail with reference to FIGS. 2-15.

The RCU 108 may, for example, measure various electrical properties at the connection points between the first hybrid converter arm 112, the second hybrid converter arm 114, the third hybrid converter arm 116, and the fourth hybrid converter arm 118. For example, the RCU 108 may adaptively regulate the AC power output. For example, the RCU 108 may be advantageously configured to control the RTGM 104 at a centralized location without requiring a high speed communication link between the power combiner system 106 and the RTGM 104.

In operation, the modular energy conversion system 100 may receive DC power from distributed sources (e.g., the one or more solar panels 110) connected to the HCMs in the RTGM 104. The HCMs may process this power and, through coordinated switching controlled by the power combiner unit 104, generate AC power at the connection point between arms. The power combiner system 106 may then condition this power for delivery to the residential building 102.

In some examples, this modular architecture may enable efficient integration of multiple renewable energy sources and energy storage systems, while providing scalable power conversion capabilities. The MECS 100 may, in some implementations, include independent maximum power point tracking (MPPT) of individual sources, potentially improving overall system efficiency.

In various implementations, a hybrid converter leg (e.g., the first and the second hybrid converter legs) each having two hybrid converter arms (e.g., the first hybrid converter arm 112 and the second hybrid converter arm 114, and the third hybrid converter arm 116 and the fourth hybrid converter arm 118) may be serially connected to a DC source (e.g., the battery 124). For example, a connection point (e.g., the common connection point 122) between the two hybrid converter arms may be adaptively controlled at a remotely located power combiner unit (e.g., the power combiner unit 104) configured to regulate an AC power generated at the connection point.

For example, each of the hybrid converter arms may include one or more serially connected hybrid converter modules (e.g., the multiple hybrid converter units 120). For example, each of the one or more serially connected hybrid converter modules may be physically attached to and receiving power input from an independent solar panel (e.g., the one or more solar panels 110). For example, each of the one or more serially connected hybrid converter modules may include a converter control circuit configured to autonomously regulate an output power based on its specific solar input conditions (e.g., using an independent Maximum Power Point Tracking (MPPT) algorithm).

For example, the remotely located power combiner unit may include a capacitor voltage sensing circuit configured to remotely measure capacitor voltages or other relevant signals of each of the one or more serially connected hybrid converter modules without a high speed communication link. For example, the remotely located power combiner unit may include a synchronizing control algorithm to control an output phase of each of the one or more serially connected hybrid converter modules as a function of output signals (e.g., a current) of other HCMs at the connection point.

FIG. 2 illustrates a block diagram of an exemplary modular power conversion system with two hybrid converter legs. As shown in FIG. 2, a MPCS 200 includes a first hybrid converter leg 202 and a second hybrid converter leg 206, each including multiple hybrid converter units 204 arranged in series. In some embodiments, the hybrid converter units 204 may be configured to generate AC power from a DC input power (e.g., from a renewable power source, a solar panel) through controlled switching operations. In this example, the first hybrid converter leg 202 and second hybrid converter leg 206 may be connected in parallel to an energy storage element 208 (e.g., a battery, a DC voltage source, a unipolar voltage source). For example, the energy storage element 208 may provide energy storage and voltage stabilization for the MPCS 200. In this example, an AC load 210 is connected to both the first hybrid converter leg 202 and second hybrid converter leg 206. For example, the AC load 210 may be a connection point in between an upper arm 212 and an lower arm 214 of each of the first hybrid converter leg 202 and the hybrid converter units 204. For example, the first hybrid converter leg 202 and the hybrid converter units 204 may generate complementary AC voltage waveforms at the connection point. For example, the series connection of hybrid converter units 204 in each of the first hybrid converter leg 202 and the hybrid converter units 204 may advantageously add an instantaneous power output from each of the hybrid converter units 204. For example, the aggregate of the instantaneous power outputs may be controlled by the RCU 108 to generate a desired output voltage for a utility grid.

In this example, eight hybrid converter units 204. In various examples, the MPCS 200 may be modified to accommodate a variety of HCMs per arm (e.g., the upper arm 212, the lower arm 214, independently). In some examples, the number of the hybrid converter units 204 per arm may not be necessarily equal.

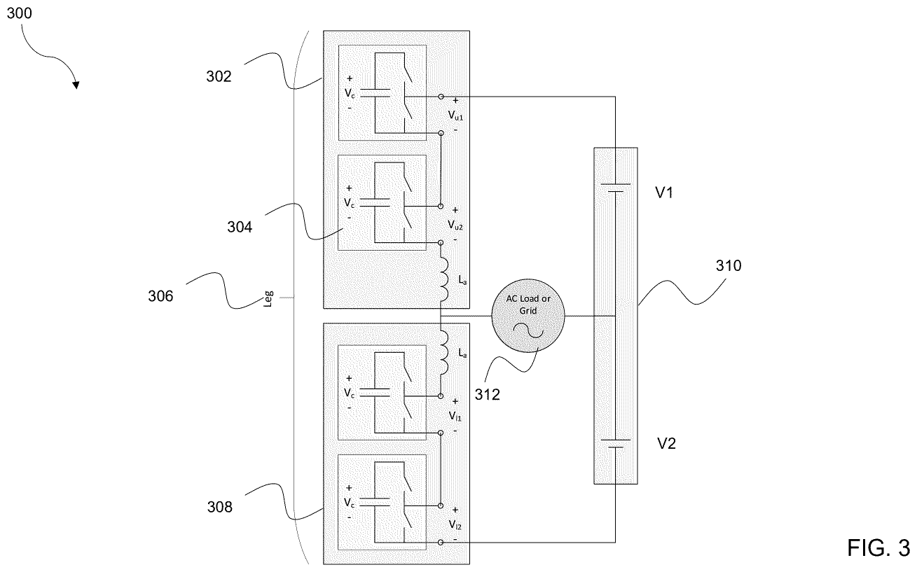

FIG. 3 illustrates a block diagram of an exemplary modular power conversion system with one hybrid converter leg. As shown in FIG. 3, MPCS 300 includes a first hybrid converter arm 302 and a second hybrid converter arm 308. For example, each of the first hybrid converter arm 302 and the 308 may include a number of hybrid converter units 304 electrically connected in series. The first hybrid converter arm 302 and second hybrid converter arm 308, for example, may form a hybrid converter leg 306. For example, the hybrid converter units 304 may include power electronic components configured to process electrical power through controlled switching operations. The hybrid converter units 304 in each arm may be electrically connected in series, enabling voltage addition from the individual units to achieve a voltage level regulated by, for example, the RCU 108. In this example, the first hybrid converter arm 302 and second hybrid converter arm 308 are serially connected to a voltage source 310. For example, the voltage source 310 may include a first voltage V1 and a second voltage V2, as shown in FIG. 3. The MPCS 300 generates an AC load 312 at a connection point between the first hybrid converter arm 302 and the second hybrid converter arm 308 in connection to a second connection point between V1 and V2. may be connected between them.

Similar to the configurations of the MPCS 300 are shown in later figures. In some examples, the MPCS 300 may include additional hybrid converter units 304 per arm and/or additional legs (e.g., to generate multiphase AC output). While not explicitly depicted in this figure, the MPCS 300 may interface with a power combiner unit as discussed elsewhere in this disclosure. The modular architecture of the MPCS 300 may provide scalability by allowing additional hybrid converter units 304 to be added to achieve the desired voltage and power levels for driving the AC load 312.

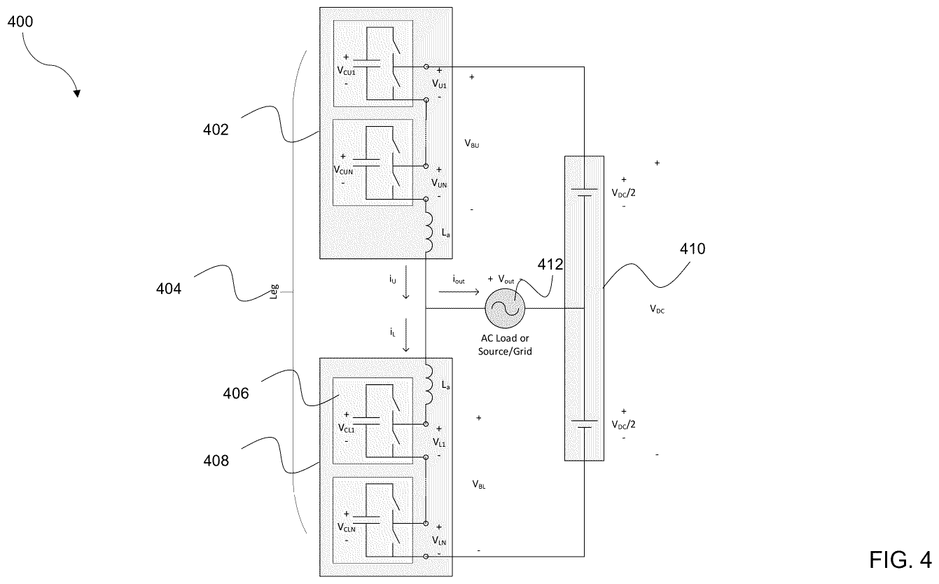

FIG. 4 illustrates another block diagram of an exemplary modular power conversion system. As shown in FIG. 4, a MPCS 400 includes a first hybrid converter arm 402 and a second hybrid converter arm 408, which together form a hybrid converter leg 404. Each arm includes multiple hybrid converter units 406 arranged in series. It should be noted that though only two are shown explicitly in each arm, others are potentially implied by the arrangement. In some examples, the hybrid converter units 406 in each arm may be electrically connected in series to enable voltage addition from the individual units. The first hybrid converter arm 402 and second hybrid converter arm 408 may be arranged symmetrically and connect at an output terminal 410, forming a leg connection point. An AC load 412 may be connected between the first hybrid converter arm 402 and second hybrid converter arm 408 at the output terminal 410. The voltage across the AC load 412 may be designated as vₒᵤₜ, and the current into the AC load is iₒᵤₜ. The current flowing into the leg connection point from the first hybrid converter arm 402 may be designated as i_{U} and the current flowing out of the connection point into the second hybrid converter arm 408 is i_{L}. Each hybrid converter unit 406 may produce an output voltage of the form V_{Ux} or V_{Lx}, wherein U or L refers to “upper” or “lower” arm, respectively, and “x” is an integer representing the number assigned to each hybrid converter unit 406. The voltages across the blocks of hybrid converter units in each arm may be V_{BU} and V_{BL}, for the upper and lower blocks, respectively. These block voltages may represent the sum of the individual hybrid converter unit voltages in each block. The hybrid converter units 406 in both arms may operate in a coordinated manner to generate complementary voltage waveforms that combine at the output terminal 410 to drive the AC load 412.

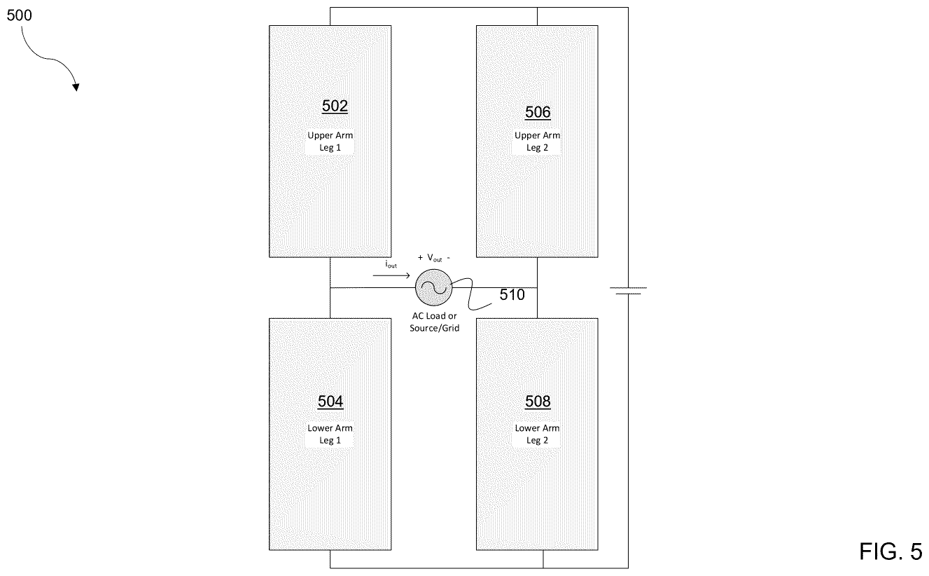

FIG. 5 illustrates a block diagram of an exemplary hybrid converter array 500 with multiple hybrid converter arms. As shown in FIG. 5, a hybrid converter array 500 includes four hybrid converter arms arranged in a symmetrical configuration. The hybrid converter array 500 may include an upper right hybrid converter arm 502, a lower right hybrid converter arm 504, an upper left hybrid converter arm 506, and a lower left hybrid arm 508, with each arm including multiple hybrid converter modules connected in series. The arms may be arranged in a quadrilateral configuration with the hybrid converter arm designated as “upper right” 502 positioned opposite to the hybrid arm 508 designated as “lower left”, and the hybrid converter arm designated as “upper left” 506 positioned opposite to the hybrid converter arm designated as “lower right” 504. It should be noted that these directional terms refer solely to the schematic representation and do not necessarily reflect the physical orientation or placement of components when installed. An AC load 510 may be connected at the center of the configuration, coupled between the connection points formed by the hybrid converter arms. Compared to the configuration shown in FIG. 3 and FIG. 4, the hybrid converter array 500 of FIG. 5 employs four arms rather than two, allowing for increased power handling capability and improved redundancy. The symmetrical arrangement may enable balanced power flow from all four arms to the AC load 510, with each arm contributing to the overall voltage and current regulation. This configuration can achieve, for example, twice the AC load voltage with a (e.g., substantially) same DC source voltage compared to a two-arm configuration, or alternatively, can achieve the same AC load voltage with half the DC source voltage. One of ordinary skill in the art can select this four-arm configuration depending on practical factors such as available DC sources, the desired AC voltage, the number of hybrid converter modules desired (which may depend on the number of solar panels, for example, that an end user plans to use), and/or a multitude of other factors.

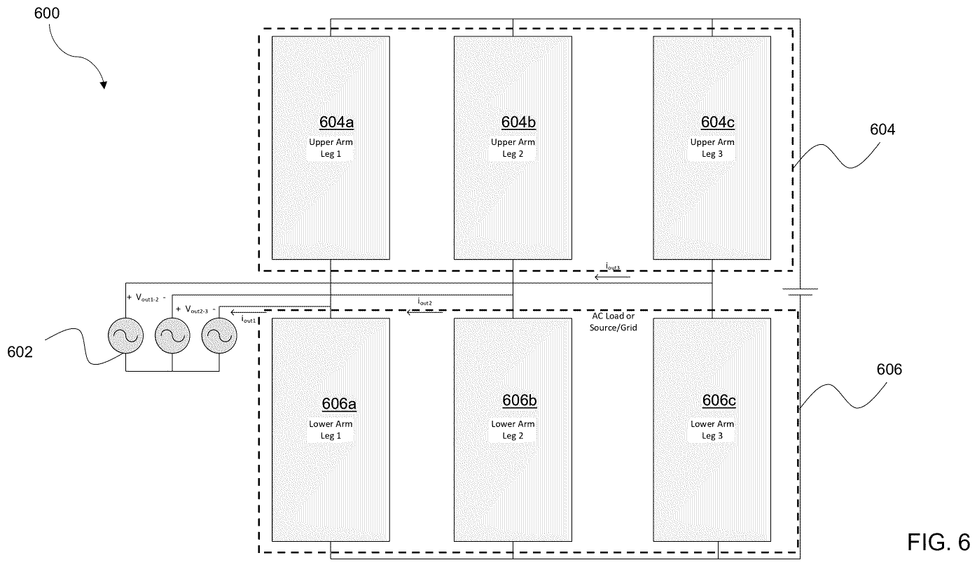

FIG. 6 illustrates a block diagram of an exemplary modular power conversion system (MPCS 600) configured to generate a three phase alternating current (AC) load 602. In this example, the MPCS 600 includes three upper hybrid converter arms 604 and three lower hybrid converter arms 606 arranged in three legs. The first upper converter arm 604a is serially connected to the first lower converter arm 606a. The second upper converter arm 604b is connected to the second lower converter arm 606b. The third upper converter arm 604c is connected to the third lower converter arm 606c.

As shown, each leg includes a connection point between the upper arm and the lower arm coupling to a corresponding one of the three-phase of the load 602. While the figure depicts a wye-connected system, for example, the MPCS 600 may be configured in other three-phase configuration (e.g., a delta-connected system). For example, the serial connection of the converter arms (604a-cand 606a-c, respectively) may enable voltage addition from individual arms while maintaining electrical isolation between stages. In various embodiments, the MPCS 600 may be extended to include other numbers of phases (e.g., 4, 6, 9, 12 phases).

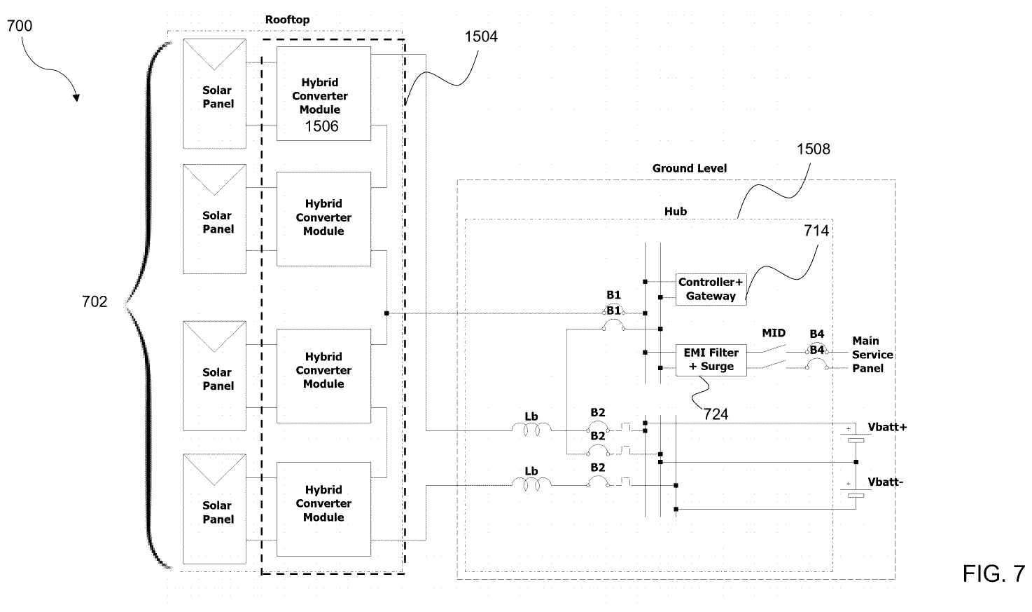

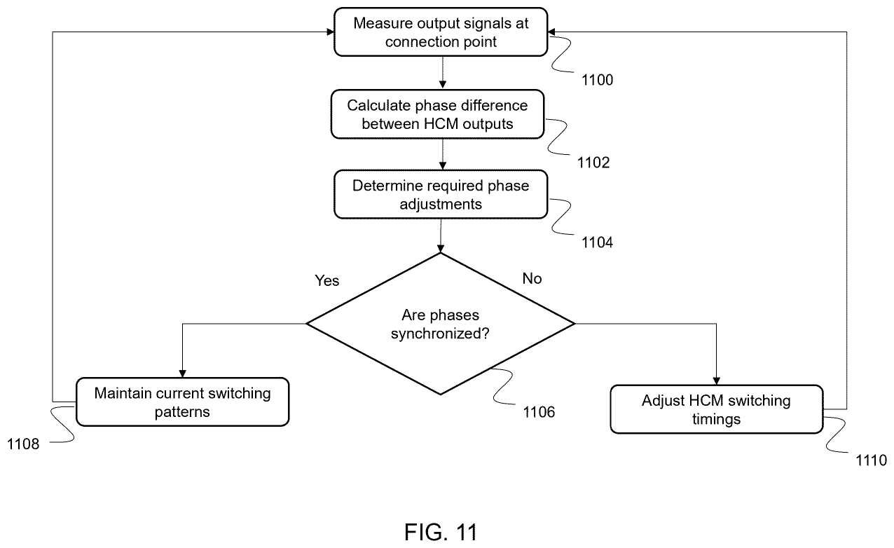

FIG. 7 illustrates a block diagram of an exemplary modular energy conversion system 700 with hybrid converter modules. As shown in FIG. 11, a modular energy conversion system 700 includes a solar panel group 702 connected to a hybrid converter module group 1104. Each solar panel in the solar panel group 702 may be connected to a corresponding hybrid converter module 706 within the hybrid converter module group 1104. Each hybrid converter module 706 may include a solar port and a pulse port. The solar port can optionally be disconnected (e.g., left open circuited) to allow for cases when the number of solar panels is fewer than the number of hybrid converter modules.

In some examples, each solar panel depicted may represent one or more solar panels in series and/or parallel, though it will be common to use one panel only or two (e.g., in series or parallel). The pulse ports of the hybrid converter modules in each arm may be connected in series. The pulse ports may produce pulses of voltage that are substantially constant for the pulse duration. The pulses may be unipolar (e.g., a positive value and a substantially zero value), or bipolar (e.g., a positive value, a negative value, and a substantially zero value). By coordinating the frequency, pulse width, and relative phase shift of the pulses, the power flow from batteries may be controlled. In combination with branch inductors and an EMI filter, a substantially sinusoidal current can be delivered to the main service panel.

In some examples, the system may include a hub 708 at ground level that couples power from batteries, hybrid converter modules, and/or the utility grid (e.g., implied by the main service panel). For example, the PCU 106 (FIG. 1) may include the hub 708. For example, the hub 708 may coordinate power flow between the hybrid converter modules, battery systems, and utility grid connections. The batteries may be housed in either the same or separate enclosures from the hub 708 and may be coupled to the hub via breakers. In some configurations, the batteries may be in a bipolar configuration with each pole and the center point coupled to a battery bus inside the hub via DC-rated circuit breakers. The hybrid converter modules may be coupled to the DC bus via branch inductors, which may be advantageously housed in the same enclosure as the hub 708. The hub 708 may include an electromagnetic interference (EMI) filter and surge protection 724 coupling the AC bus bars to the MID and/or the AC power grid and/or AC load. The EMI filter may satisfy compliance requirements in addition to reducing electrical noise in the system. Placing an EMI filter in the hub 708 may demonstrate the use of an EMI filter in the hybrid converter modules, resulting in significant size, cost, and/or part count savings. Similarly, the surge protection circuitry may mitigate overvoltage events associated with the AC power grid from reaching upstream components.

In some examples, the hub 708 may include a gateway controller 714 that may be used to coordinate power, voltage, and/or current from the various hybrid converter modules, as well as conduct measurements of relevant signals within the hub. The gateway controller 714 may include communication circuitry for communicating with the hybrid converter modules and possibly other devices, inside or outside the hub. The gateway controller 714 may advantageously measure AC power grid voltage, current, and/or power for both monitoring and/or compliance purposes, determine phase shift of the voltage using techniques such as phase-locked loop (PLL), detect abnormal voltage conditions, and/or ascertain islanded conditions of the AC power grid.

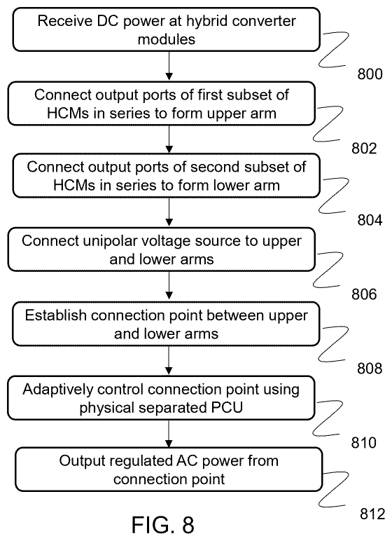

FIG. 8 illustrates a flowchart of an exemplary method for operating a modular energy conversion system. At step 800, DC power is received at hybrid converter modules. For example, the solar panel array 3102 and battery system 3116 in FIG. 31 may provide DC power to the hybrid converter modules 3106.

At step 802, output ports of a first subset of HCMs are connected in series to form an upper arm. For example, multiple hybrid converter modules 3106 in FIG. 31 may be electrically connected in series to form an upper arm of the modular energy conversion system 3100.

At step 804, output ports of a second subset of HCMs are connected in series to form a lower arm. For example, another set of hybrid converter modules 3106 in FIG. 31 may be electrically connected in series to form a lower arm of the modular energy conversion system 3100.

At step 806, a unipolar voltage source is connected to the upper and lower arms. For example, the battery system 3116 in FIG. 31 may be connected to both the upper and lower arms formed by the hybrid converter modules 3106.

At step 808, a connection point is established between the upper and lower arms. For example, the power combiner unit 3108 in FIG. 31 may serve as a connection point between the upper and lower arms formed by the hybrid converter modules 3106.

At step 810, the connection point is adaptively controlled using a physically separated PCU. For example, the controller 3110 within the power combiner unit 3108 in FIG. 31 may adaptively control the connection point between the upper and lower arms of hybrid converter modules 3106.

At step 812, regulated AC power is output from the connection point. For example, the power combiner unit 3108 in FIG. 31 may output regulated AC power to the main service panel 3118 or external power grid 3126.

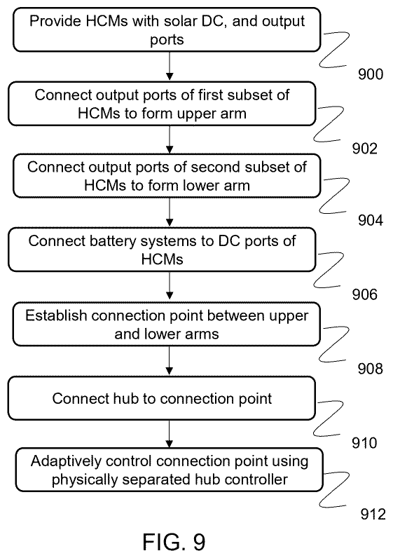

FIG. 9 illustrates a flowchart of an exemplary method for configuring hybrid converter modules. At step 900, HCMs are provided with solar DC and output ports. For example, the hybrid converter modules 3106 in FIG. 31 may be equipped with solar DC inputs from the solar panel array 3102 and output ports for connection to other system components.

At step 902, output ports of a first subset of HCMs are connected in series to form an upper arm. For example, multiple hybrid converter modules 3106 in FIG. 31 may be electrically connected in series to form an upper arm of the modular energy conversion system 3100.

At step 904, output ports of a second subset of HCMs are connected in series to form a lower arm. For example, another set of hybrid converter modules 3106 in FIG. 31 may be electrically connected in series to form a lower arm of the modular energy conversion system 3100.

At step 906, battery systems are connected to DC ports of the HCMs. For example, the battery system 3116 in FIG. 31 may be connected to DC ports on the hybrid converter modules 3106 to provide energy storage capabilities.

At step 908, a connection point is established between the upper and lower arms. For example, the power combiner unit 3108 in FIG. 31 may serve as a connection point between the upper and lower arms formed by the hybrid converter modules 3106.

At step 910, a hub is connected to the connection point. For example, the power combiner unit 3108 in FIG. 31 may be connected to the established connection point between the upper and lower arms of hybrid converter modules 3106.

At step 912, the connection point is adaptively controlled using a physically separated hub controller. For example, the controller 3110 within the power combiner unit 3108 in FIG. 31 may adaptively control the connection point between the upper and lower arms of hybrid converter modules 3106.

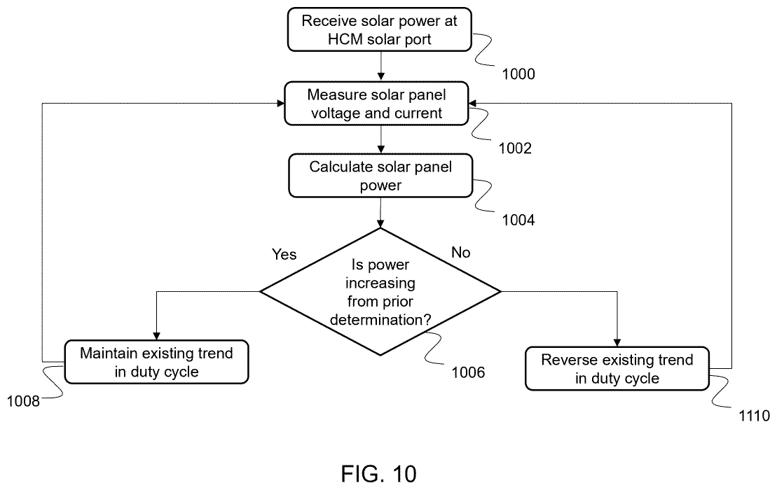

FIG. 10 illustrates a flowchart of an exemplary solar power control process. At step 1000, solar power is received at a HCM solar port. For example, the solar panel 3104 in FIG. 31 may provide solar power to the solar port of a hybrid converter module 3106.

At step 1002, solar panel voltage and current are measured. For example, the hybrid converter module 3106 in FIG. 31 may measure the voltage and current output from the connected solar panel 3104.

At step 1004, solar panel power is calculated based on the measured voltage and current values. For example, the controller 3110 within the power combiner unit 3108 in FIG. 31 may calculate the power output of each solar panel 3104 using the measurements from the hybrid converter modules 3106.

At step 1006, a determination is made whether the power is increasing from prior determination. For example, the controller 3110 in FIG. 31 may compare the calculated power to determine whether the power increased or decreased form the last iteration of the loop.

If the power is increasing, the process proceeds to step 1008, where the existing trend in duty is maintained. For example, the hybrid converter module 3106 in FIG. 31 may maintain its current operating parameters.

If the power is not increasing (e.g., decreasing), the process moves to step 1010, where the existing trend in duty cycle is reversed. For example, the hybrid converter module 3106 in FIG. 31 may adjust its internal DC-DC converter duty cycle.

After steps 1008 or 1110, the process returns to step 1002 to continue monitoring and optimizing solar power output. For example, the hybrid converter modules 3106 and controller 3110 in FIG. 31 may continuously cycle through these steps to maintain optimal power extraction from the solar panel array 3102.

FIG. 11 illustrates a flowchart of an exemplary process for synchronizing hybrid converter module outputs. At step 1100, output signals are measured at a connection point. For example, the voltage sensor 728 in FIG. 31 may measure voltage signals at the connection point between the hybrid converter modules 3106 and the power combiner unit 3108.

At step 1102, the phase difference between HCM outputs is calculated. For example, the controller 3110 within the power combiner unit 3108 in FIG. 31 may calculate phase differences between the outputs of multiple hybrid converter modules 3106.

At step 1104, required phase adjustments are determined based on the calculated phase differences. For example, the controller 3110 in FIG. 31 may determine necessary phase adjustments for each hybrid converter module 3106 to achieve synchronization.

At decision step 1106, a determination is made whether the phases are synchronized. For example, the controller 3110 in FIG. 31 may compare the calculated phase differences to a predetermined synchronization threshold.

If the phases are synchronized, the process moves to step 1108, where current switching patterns are maintained. For example, the controller 3110 in FIG. 31 may maintain the existing switching patterns for the hybrid converter modules 3106.

If the phases are not synchronized, the process proceeds to step 1110, where HCM switching timings are adjusted. For example, the controller 3110 in FIG. 31 may modify the switching timings of individual hybrid converter modules 3106 to achieve phase synchronization.

After steps 1108 or 1110, the process returns to step 1100 to continue monitoring and adjusting output signals. For example, the voltage sensor 728 and controller 3110 in FIG. 31 may continuously cycle through these steps to maintain synchronized operation of the hybrid converter modules 3106 in the modular energy conversion system 3100.

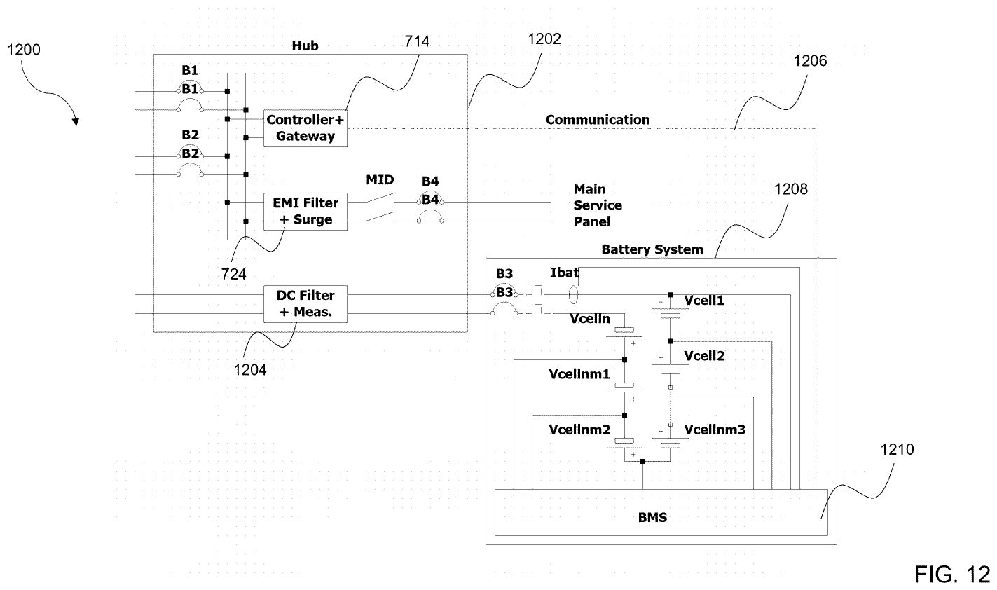

FIG. 12 illustrates a block diagram of an exemplary hub and battery system 1200 for energy conversion. As shown in FIG. 12, the hub 1202 includes multiple connection points labeled B1, B2, B3, and B4, with B1 and B2 serving as solar branch circuit inputs. A gateway controller 714 may be positioned within the hub 1202 to manage system operations and/or communications. The hub 1202 may incorporate an EMI filter and/or surge protection module 724 for power conditioning.

In some examples, a DC filter module 1204 may be connected to the hub 1202, providing filtering and/or measurement capabilities. The DC filter module 1204 may couple the DC ports of the HCMs to the battery system and may include inductors and/or capacitors to attenuate switching-induced voltage and/or current ripple from the HCMs. The measurement aspect may allow the controller to directly measure battery system voltage and/or current upstream of the battery system itself, which may be advantageous compared to relying solely on communication from the battery management system.

In some examples, the system may include a battery interface 1206 that connects to a battery system 1208. The battery system 1208 may include multiple voltage cells (Vcell1, Vcell2, Vcellnm1, Vcellnm2, Vcellnm3) arranged in a string to produce the total battery voltage. A battery management system (BMS) 1210 may be integrated within the battery system 1208 to monitor and/or control the battery cells. The BMS 1210 may provide cell balancing, measurements of cell voltage and string current, and may conduct calculations for state of charge (SOC), state of health (SOH), and/or temperature measurements for the cells.

In some examples, DC breaker B4 may provide a way to disconnect the battery system 1208 from the hub 1202 in case of overcurrent, overvoltage, temperature issues, and/or other faults. The breaker may be implemented as a controllable disconnect so that the BMS may selectively open or close the connection to the hub. The battery system 1208 may include a communication line to the hub controller and/or gateway. Each cell may comprise a single battery cell or, in some embodiments, a group of battery cells, cassettes, and/or modules.

In some examples, the components may be arranged to enable power flow between the hub 1202 and the battery system 1208, with filtering and/or protection provided by the EMI filter and surge 724 and/or DC filter module 1204. Multiple battery systems may be coupled to the hub in various configurations, including series and/or parallel arrangements to achieve desired voltage, current, and/or total capacity.

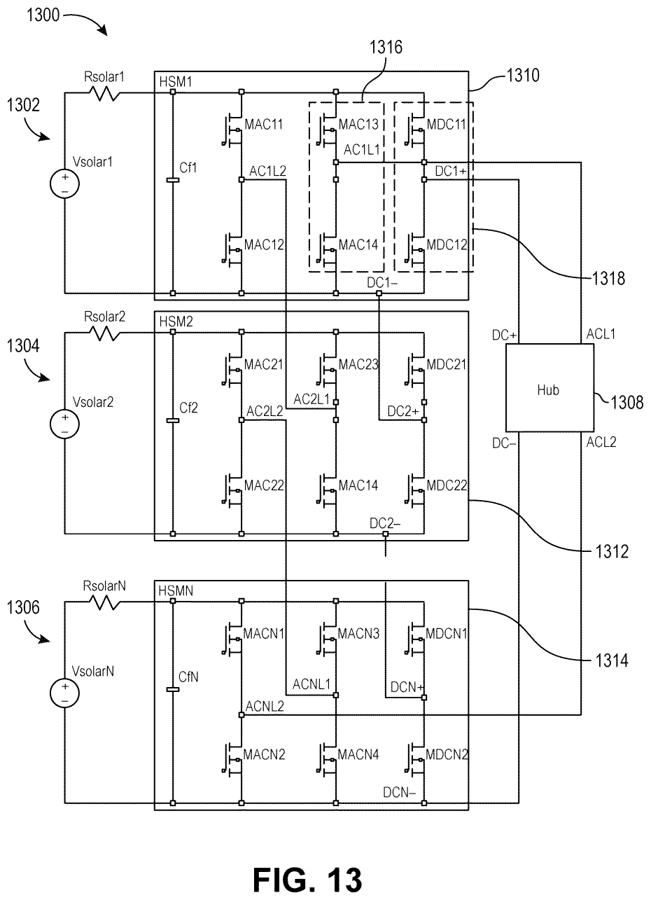

FIG. 13 illustrates a circuit diagram of an exemplary solar branch 1300 circuit with multiple circuit blocks. As shown, the diagram depicts first circuit block 1302, second circuit block 1304, and third circuit block 1306 connected to a hub 1308. Each circuit block may represent a Hybrid Series Module (HSM) with both AC and DC ports. The collective output from the AC and DC ports of the HSMs may be provided to the hub 1308. Each HSM's solar port may be connected to a solar panel, represented by a circuit model comprising a voltage source (Vsolar) and panel resistance (Rpanel).

Within each circuit block, transistors arranged in an H-bridge configuration (shown as MAC1-MAC4 in the first circuit block 1302) may convert the DC voltage provided by the solar panel to an AC voltage between connection points. By adjusting the switching frequency, pulse width, and/or duty cycle of the gating waveforms applied to these transistors, the amount of AC voltage, current, and power provided to the AC port can be controlled. Similarly, by adjusting the switching frequency, pulse width, and/or duty cycle of the gating waveforms applied to the DC transistors (shown as DC+ and DC− in each block), the amount of DC voltage, current, and/or power provided by the DC port can be regulated. Each HSM may include a relatively small filter capacitance (CF).

This configuration depicts the absence of bulk capacitance that would typically be present in conventional or series microinverters. Instead, the power ripple inherent to single-phase power may be directed to a battery system via the DC ports of the HSMs. This may effectively displace the typical bulk capacitance with the battery system, which behaves as a large capacitor handling voltage, current, and/or power ripple in addition to its normal battery system function of large-scale charging and/or discharging.

In some examples, the circuit may provide bypass capability for failed or inoperable HSMs. Since the HSMs are connected in series, the failure of one HSM may potentially shut down an entire branch circuit. To mitigate this, certain transistors within each HSM may be utilized as a bypass mechanism for the AC port, allowing current to flow through without interacting with other components of the HSM, effectively shorting out the AC port of a failed module.

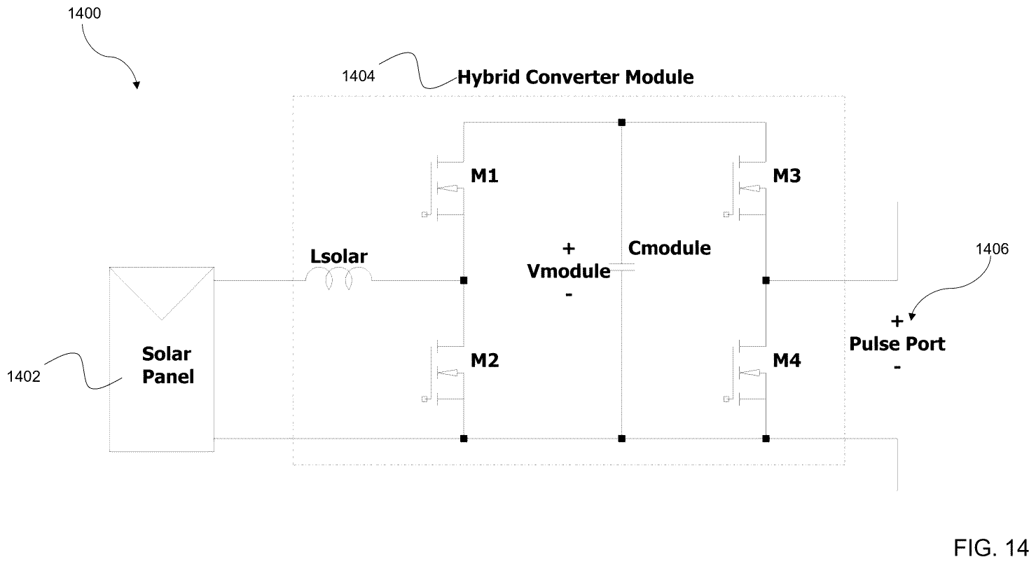

FIG. 14 illustrates a circuit diagram of an exemplary modular energy conversion system 1400 with a hybrid converter module 1404. As shown in FIG. 14, the modular energy conversion system 1400 includes a solar panel 1402 connected to a hybrid converter module 1404. The hybrid converter module 1404 includes a solar DC-DC converter formed by MOSFETs M1 and M2 that couples to the solar panel 1402 via inductor Lsolar. This solar DC-DC converter may be controlled using pulse width modulation and/or control techniques, which may include analog and digital methods of maximum power point tracking (MPPT). The purpose of MPPT may be to maximize power flow from the solar panel 1402, though MPPT efforts may be temporarily suspended to handle transient conditions, faults such as overvoltages, and/or other events. While depicted as a classic synchronous boost converter, various DC-DC converter technologies could be implemented.

In some examples, the solar DC-DC converter may couple to capacitor Cmodule, which may include one or more capacitors in parallel or series to achieve desired energy storage, capacitance, and/or voltage withstand capability. Capacitor Cmodule may maintain a relatively constant DC voltage (Vmodule) with some degree of ripple that varies with operating conditions. Since Cmodule can vary in DC voltage level and ripple, it may not store as much energy as Cbulk in conventional or single-stage microinverters, allowing for significantly smaller capacitance.

In some examples, a capacitor Cmodule may connect to pulse transistors M3 and M4, which may control the pulse port 1406 output. When M3 is turned on and M4 is off, Vmodule may appear at the pulse port 1406. When M4 is turned on and M3 is turned off, substantially zero volts may be present at the pulse port 1406. By alternately switching between these two states, the voltage at the pulse port 1406 may alternate between substantially zero volts and substantially Vmodule. Small differences between these two voltages may exist due to factors such as voltage drops across transistors M3 and M4.

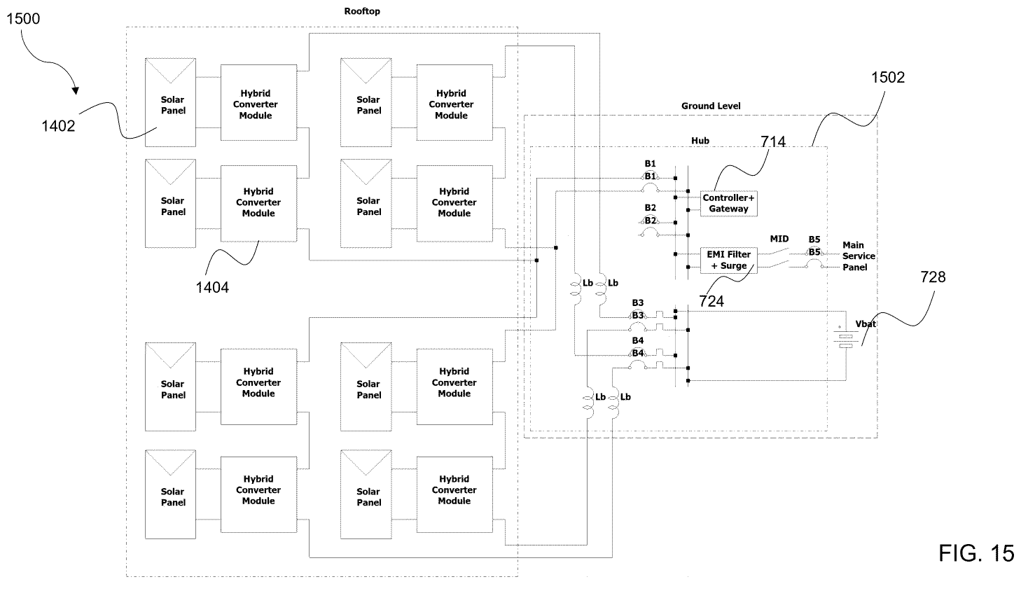

FIG. 15 illustrates a block diagram of an exemplary modular energy conversion system 1500 with rooftop and ground-level components. As shown in FIG, 15, the modular energy conversion system 1500 includes rooftop and ground level components. The system includes multiple solar panels 1402 arranged in two rows at the rooftop level, with each solar panel 1402 connected to a corresponding hybrid converter module 1404. The hybrid converter modules 1404 may be connected in series within each row to form upper and lower arms. The terms “hybrid converter modules” and “hybrid converter units” are used interchangeably throughout this document to refer to the same power conversion components. For example, the hub 1502 functionality may be implemented by the system controller 108 (as illustrated in FIG. 1). In some implementations, the gateway controller 714 may include a Remote Control Unit (e.g., the RCU 108), for example, working in tandem with the PCU 106. For the purposes of this disclosure, the terms “controller,” and “RCU” may be used interchangeably to refer to the same component or system element that coordinates power flow between the hybrid converter modules, battery systems, and utility grid connections. The solar panel 110 in FIG. 1 is the same as the solar panel 1402 described in FIG. 14. At ground level, the system includes a hub 1502 that includes a gateway controller 714 for managing system operation and an EMI filter and surge protection module 724 for conditioning power signals. A voltage sensor 728 may monitor electrical conditions in the system. The hybrid converter modules 1404 connect to the hub 1502 through multiple connection points labeled B1, B2, B3, B4, and B5. This configuration enables power conversion between the solar panels 1402 and a main service panel through the coordinated operation of the hybrid converter modules 1404 and hub 1502 components. The system may employ a unipolar battery configuration rather than a bipolar battery, which may be simpler for implementation while still allowing the upper and lower arms to work in tandem to generate AC voltage. This arrangement may be particularly suitable for larger systems with more power capacity and/or more solar panels, as it can generate more voltage levels than configurations with fewer HCMs and only one set of arms.

FIG. 16 illustrates a block diagram of an exemplary modular energy conversion system with a RTGM 104. As shown in FIG. 16, the RTGM 104 is connected to a power combiner system 106. The RTGM 104 includes multiple hybrid converter arms arranged in a configuration with first hybrid converter arm 112, second hybrid converter arm 114, third hybrid converter arm 116, and fourth hybrid converter arm 118. Each arm includes multiple hybrid converter units connected in series, with first hybrid converter unit 1610a, second hybrid converter unit 1610b, and third hybrid converter unit 1610c shown in one of the arms. Each hybrid converter unit may be associated with zero or more solar panels and/or other types of solar power generators.

In some examples, the hybrid converter units within each arm may be wired in series, with the four arms organized into two “legs.” Each leg may consist of two arms coupled together, with one arm connected to the positive terminal of a battery module 1608 and the other arm connected to the negative terminal. The arms in each leg may be coupled together at connection points. The connection points of each leg may then be coupled to an AC load, which in this embodiment is shown connected through a power meter 1602 and a main service panel 1604.

In some examples, a combiner 1606 may interface between the RTGM 104, the battery module 1608, and/or the power meter 1602. The combiner 1606 may include wiring to configure the hybrid converter arms into the appropriate arrangement and include branch inductors for each arm. The combiner 1606 may include electromagnetic interference (EMI) filtering and surge protection circuitry to reduce electrical noise and suppress harmful transients. The modular energy conversion system may demonstrate how multiple hybrid converter units can be arranged in arms and legs to enable power conversion between solar inputs, battery storage, and/or AC power distribution.

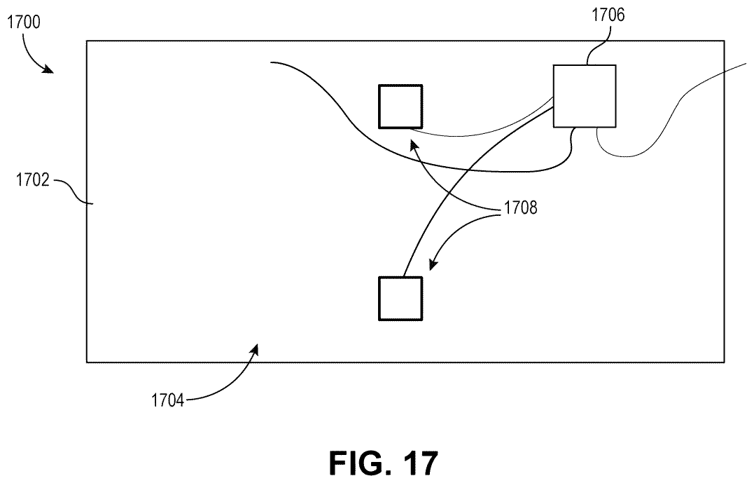

FIG. 17 illustrates a block diagram of an exemplary hybrid converter system 1700 interfacing with a solar panel 1704. As shown in FIG. 17, a hybrid converter system 1700 includes a hybrid converter module 1702 connected to a solar panel 1704 through j-boxes 1708. The hybrid converter module 1702 may process power from the solar panel 1704 and deliver it to a power combiner unit 1706. The solar panel 1704 may connect to the hybrid converter module 1702 via multiple j-boxes 1708, which provide electrical connection points between these components. The hybrid converter module 1702 may be positioned adjacent to the solar panel 1704 to facilitate efficient power transfer.

In some examples, the power combiner unit 1706 may receive the processed power from the hybrid converter module 1702 through electrical connections shown in the diagram. This configuration may represent one possible implementation of the hybrid converter system described in the invention. It should be noted that while FIG. 17 shows a single solar panel 1704 connected to one hybrid converter module 1702, the system can be expanded to include multiple solar panels and hybrid converter modules arranged in groups. As described elsewhere in this disclosure, such groups can be configured into arms and legs within a larger system architecture.

In some examples, the solar panel 1704 may represent various types of solar power generators, including photovoltaic modules, solar shingles, and/or other building-integrated solar materials. The j-boxes 1708 may provide standardized connection points that facilitate installation and/or maintenance of the system. The hybrid converter module 1702 may be configured to perform various power conversion functions, including maximum power point tracking for the solar panel 1704, before sending the processed power to the power combiner unit 1706.

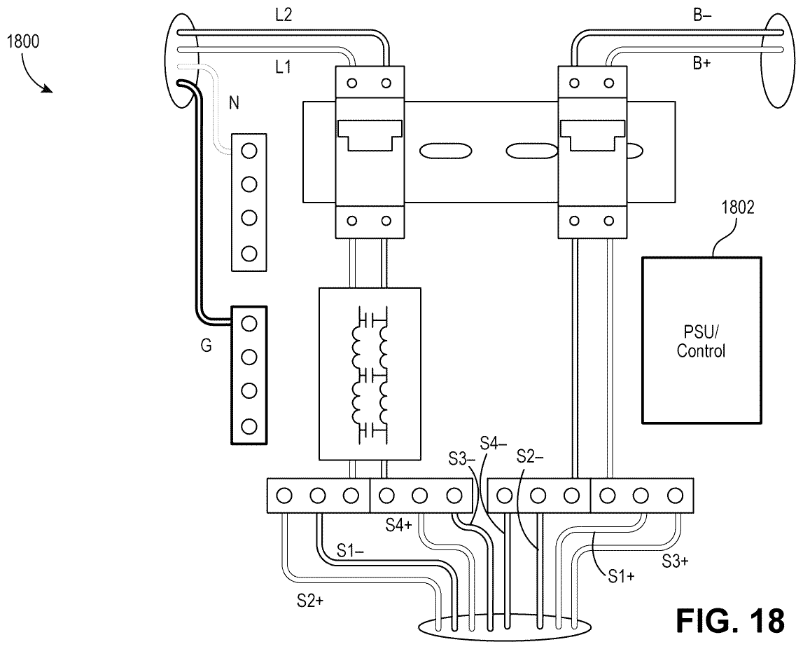

FIG. 18 illustrates a circuit diagram of an exemplary power combiner unit 1800 with multiple terminal connections. As shown, the power combiner unit 1800 includes a control module 1802 labeled as “PSU/Control” that provides power to the control circuitry and possibly other components within the unit. The control module 1802 may include circuitry for measuring various signals, such as voltage, current, power, temperature, and others present in the power combiner unit 1800. The control module 1802 may include communication circuitry for sending and/or receiving information to or from the hybrid converter modules (HCMs). The power combiner unit 1800 may include multiple terminal connections including first line terminal L1, second line terminal L2, and multiple string terminal pairs (S1+/S1−, S2+/S2−, S3+/S3−, S4+/S4−) arranged in terminal blocks to facilitate connections between various components. Additional communication circuitry may be included for exchanging information with a server located on an internet and/or other external devices, though detailed connections to/from the control module 1802 are not explicitly shown in the diagram. The terminal blocks may be configured to establish electrical connections between the string terminals and other circuit components, enabling multiple string inputs to be combined and processed through the power combiner unit 1800 under the supervision of the control module 1802.

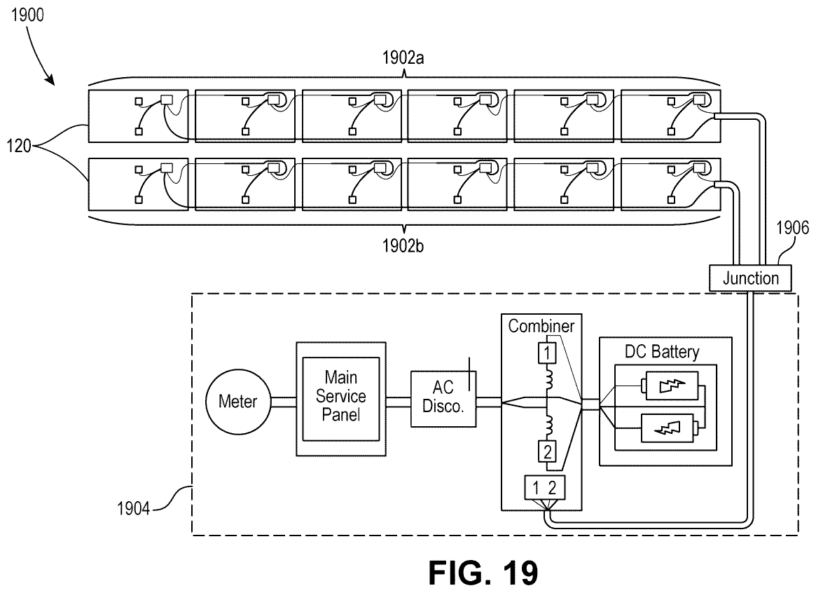

FIG. 19 illustrates a block diagram of an exemplary modular energy conversion system 1900 with hybrid converter modules. As shown in FIG. 19, hybrid converter modules may be arranged in a hybrid converter array 1902. The hybrid converter modules 1900 may be grouped into two groups of six, with each group connected in series to form rows within the hybrid converter array 1902. The two groups may be brought together at a power combiner system 1904 and configured into two arms forming a single leg. The system may include a junction 1906 that provides an interface between the hybrid converter array 1902 and the power combiner system 1904. In this configuration, the battery system may include a positive, negative, and common wire, such that a bipolar voltage is generated. This bipolar voltage can be implemented either by providing a battery with a bipolar output as shown in the figure, or with two batteries that are configured as bipolar in the power combiner system 1904. The arrangement may allow for efficient power conversion between the hybrid converter modules 1900 and the power combiner system 1904 through the established electrical connections.

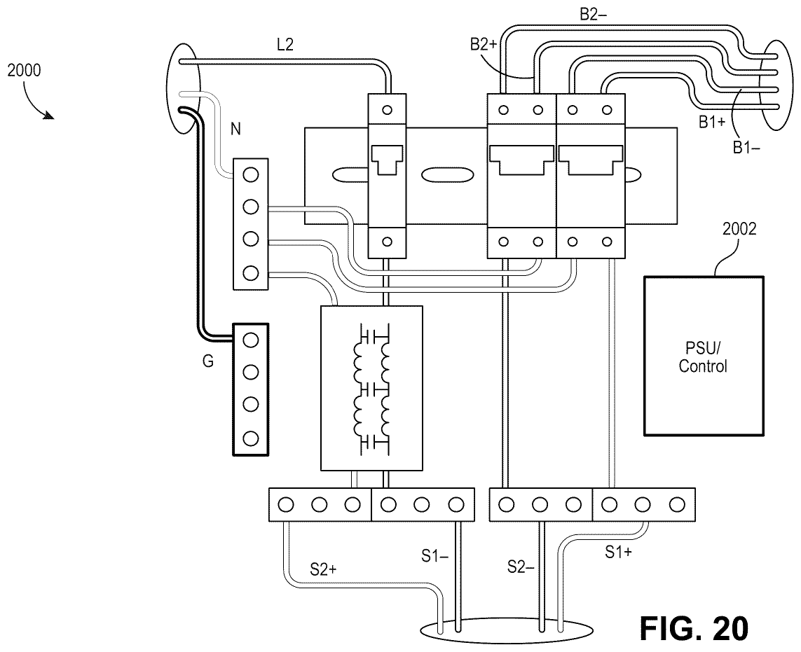

FIG. 20 illustrates a circuit diagram of an exemplary power combiner unit 2000 with multiple terminal connections. As shown in FIG. 20, the power combiner unit 2000 includes a control module 2002 labeled as “PSU/Control” that provides power to control circuitry and/or manages system operation. The power combiner unit 2000 may include multiple terminal connections arranged in rows. The terminal connections may include line (L2), neutral (N), and ground (G) terminals positioned along one side of the unit. The power combiner unit 2000 may include several terminal blocks for connecting multiple string inputs, labeled as S1+, S1−, S2+, and S2−. These terminal blocks may facilitate connections between different power conversion strings. Battery connections labeled B1+, B1−, B2+, and B2− may be provided within the power combiner unit 2000, allowing two batteries to be coupled to the terminal blocks via circuit breakers and/or other suitable devices. The neutral (N) connection may be coupled to the battery common via terminal blocks as shown. An EMI filter may be coupled to an AC power grid via a circuit breaker, with the power grid depicted as L2, N, and G (e.g., line 2, neutral, and ground, respectively). This configuration may represent a common “split-phase” connection in the US power grid, where the combiner is coupling to the second phase (L2-N) of the split-phase connection, typically 120V in the US. The system, in some examples, may be configured for line-to-line coupling (e.g., typically 240V in the US) or to couple groups to both phases (L1-N and L2-N). In this embodiment, the system may include two arms and one leg.

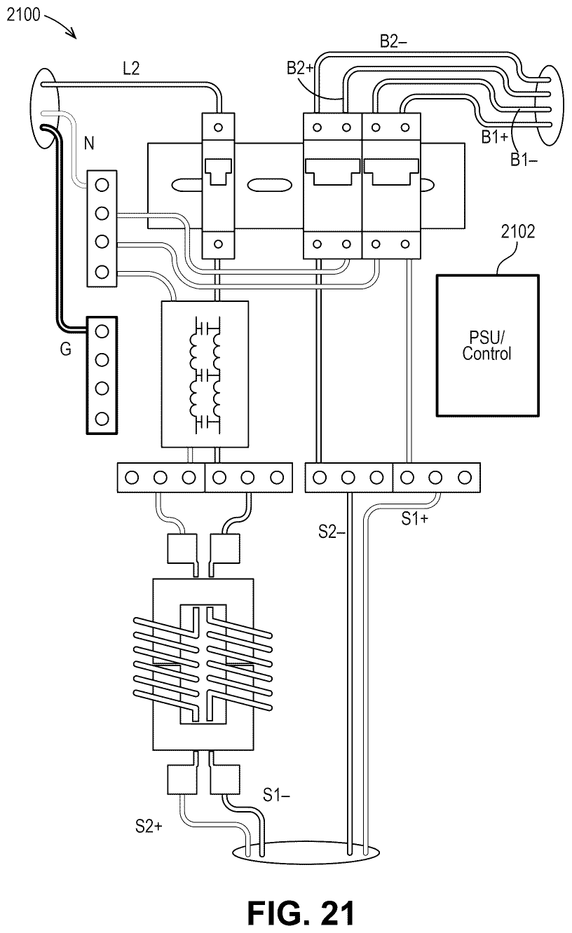

FIG. 21 illustrates another circuit diagram of an exemplary power combiner unit 2100 with control components. As shown in FIG. 21, the power combiner unit 2100 includes multiple terminal blocks arranged in rows for connecting various power conversion components. While not explicitly depicted in FIG. 21, inductors can be implemented in the power combiner unit 2100. In some examples, the inductors may be distributed among the HCMs as shown in other figures. In some examples, inductors can be placed in each arm coupled on a single core, though they may, in some examples, be implemented on separate cores (substantially magnetically uncoupled). The power combiner unit 2100 can be configured to support various arrangements of HCMs into arms and legs for coupling to AC loads or AC power grids. For example, three legs may be used to couple to a three-phase AC power grid or AC load, which may be either wye-or delta-connected, with each of the three connection points between the arms of each leg coupled to the corresponding AC load or AC source terminals. The number of HCMs per group can be increased or decreased to meet voltage requirements, allowing the same HCM hardware to couple to various AC voltage loads and/or sources including 120V single-phase, 240V split-phase, 230V single-phase, 400V three-phase, 277V single-phase, 480V three-phase, and others. There is no implied limit on the number of legs, enabling support for higher numbers of phases, such as six legs with each pair of two legs driving one phase of a three-phase system where the phases are independent (not wye-or delta-connected).

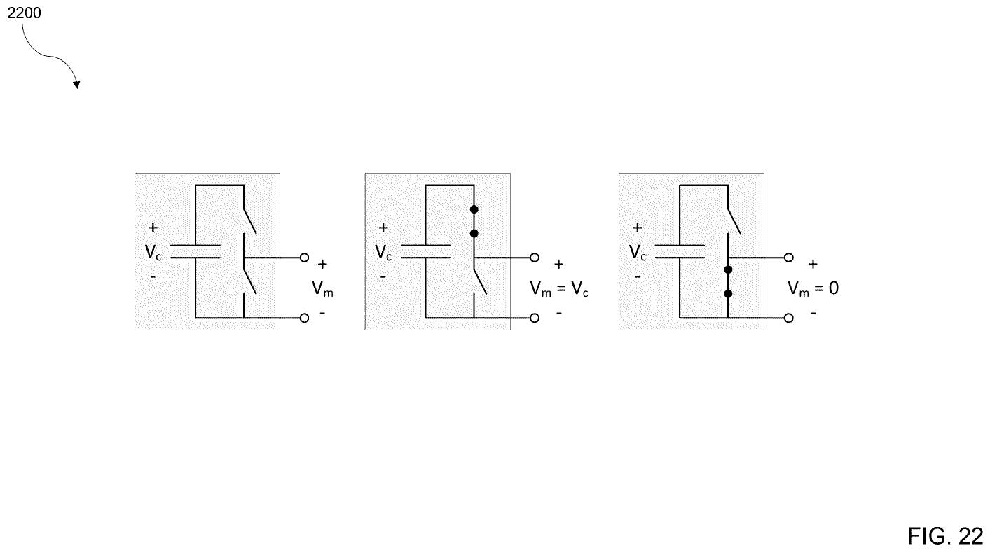

FIG. 22 illustrates circuit diagrams of exemplary operating states of a hybrid converter unit 2200. As shown, three operating states of a hybrid converter unit 2200 are depicted. The diagram depicts three identical circuit configurations positioned side by side, each showing different switching states. The hybrid converter unit 2200 includes a capacitor labeled Vc with positive and negative terminals, and two switches arranged to control the output voltage Vm. In the leftmost configuration, both switches are shown in an open state, with the output voltage Vm undefined. The center configuration shows the upper switch closed and lower switch open, resulting in an output voltage Vm equal to Vc. The rightmost configuration shows the upper switch open and lower switch closed, producing an output voltage Vm of zero volts. The switches may be implemented with power semiconductors, such as power MOSFETs and/or IGBTs, based on silicon, silicon carbide, gallium nitride, and/or other suitable power semiconductor technology. The capacitor can be implemented with any suitable capacitor technology. Not shown in the diagram are the control and gate drive circuits used to toggle the switches. It should be noted that both switches would generally not be closed simultaneously, at least not intentionally, as that would cause a short circuit across Vc and could potentially be destructive to the circuit.

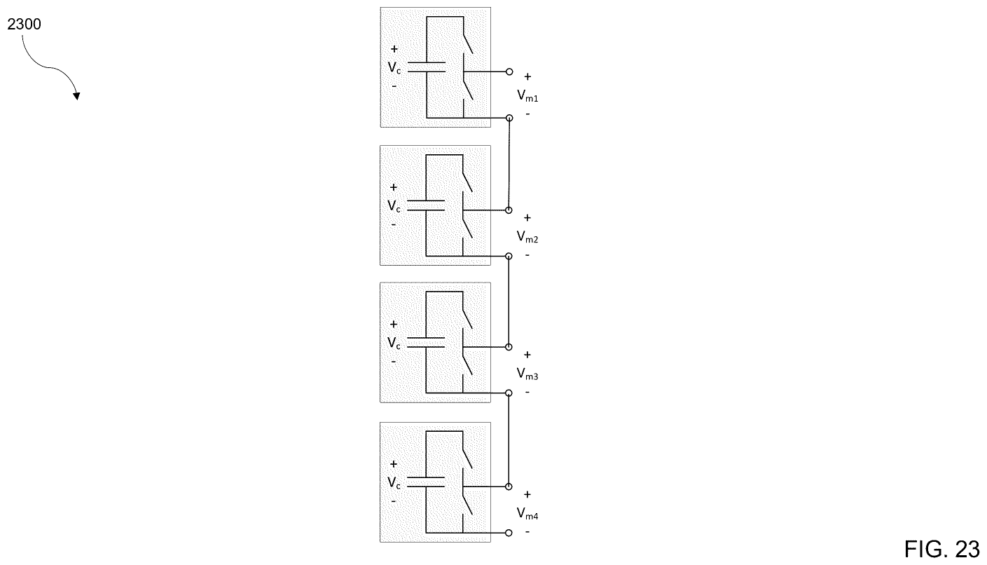

FIG. 23 illustrates a circuit diagram of an exemplary hybrid converter unit 2300 with multiple switching cells. As shown, the diagram depicts four identical circuit blocks arranged vertically, with each block including a switching arrangement and output terminals. Each block includes two switches connected to a capacitor, forming a basic switching cell configuration. The switches in each block can be independently controlled to produce different output voltages (Vm1, Vm2, Vm3, and Vm4). When connected in series as shown, the hybrid converter unit 2300 may produce an aggregate voltage (Vm1+Vm2+Vm3+Vm4) having five different levels. The capacitor voltages in each block are theoretically equal, but in practice may differ slightly due to control transients, component tolerances, and/or other practical considerations. The arrangement may allow for voltage addition through the series connection of the individual blocks, with each block independently controlling its output voltage through the operation of its switches.

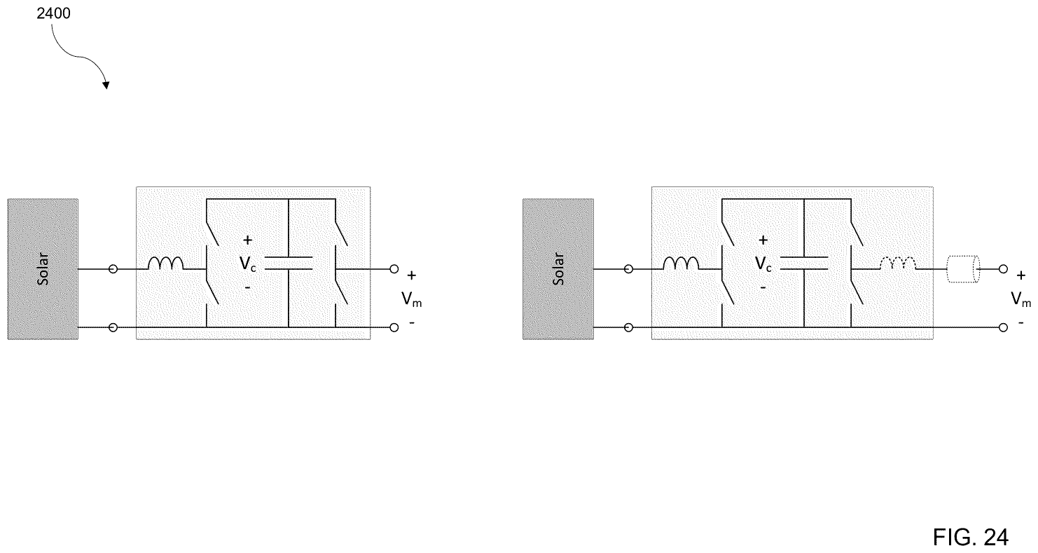

FIG. 24 illustrates circuit diagrams of exemplary variations of a solar-enabled hybrid converter unit 2400. As shown, the diagram depicts two circuit configurations positioned side by side, each showing a different implementation approach. In both configurations, a solar panel (e.g., or other solar generator) may be coupled to a solar input port of the solar-enabled hybrid converter unit 2400. The left configuration shows a solar-enabled hybrid converter unit 2400 including an inductor connected to a switching circuit with two switches and a capacitor labeled Vc. The switches may be arranged to control the output voltage Vm across the output terminals marked with positive and negative polarities. The right configuration shows a similar solar-enabled hybrid converter unit 2400 that includes an additional inductor at the output stage, positioned between the switching circuit and the output terminals marked Vm. The solar input in both configurations may couple through a solar inductor to switches, which form a solar DC-DC converter that couples to the capacitor Vc. The switches for the solar DC-DC converter can be selected from a number of suitable technologies and/or commercially available devices. These switches may be controlled to extract power from the solar panel, preferably using a maximum power point tracking (MPPT) algorithm that tends to substantially maximize the amount of solar power. The leftmost diagram may depict the solar-enabled hybrid converter unit 2400 without an inductor on the output, essentially requiring that arm inductors be implemented elsewhere, outside of the unit (e.g., such as in a combiner). The rightmost diagram may depict an option for implementing at least a portion of the arm inductor within the unit itself. In this case, the arm inductance may become substantially the sum of the individual inductances of each unit, potentially demonstrating a single, larger arm inductor that could otherwise be housed in a combiner and/or other enclosure.

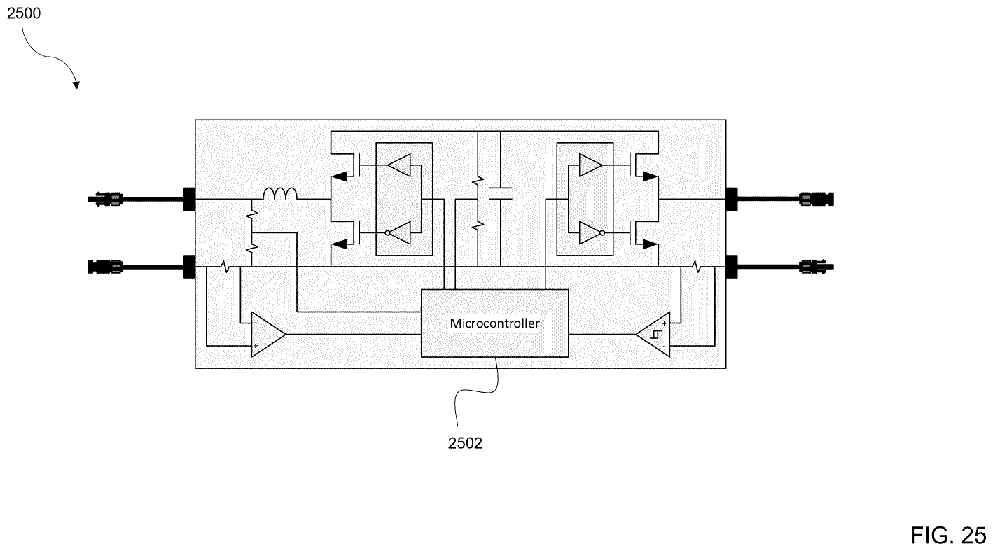

FIG. 25 illustrates a circuit diagram of an exemplary solar-enabled hybrid converter unit 2500 with a microcontroller 2502. For example, the solar-enabled hybrid converter unit 2500 may be used as one of the multiple hybrid converter units 120 as described with reference to FIG. 1. In some examples, the switches may be implemented with power MOSFETs, which are driven by gate drivers that are shown coupled between the microcontroller unit 2502 and the power MOSFETs. The microcontroller unit 2502, which may be any suitable control circuit that is software programmable, may be configured to read sensor data from at least the solar input, the output, and/or capacitor voltage. Based on sensor readings and information received over a communication channel (not shown), the microcontroller unit 2502 can calculate when to actuate each switch to achieve the desired power from the solar panel and desired voltage out of the solar-enabled hybrid converter unit 2500, and, therefore, the desired aggregate voltage produced by the arms and legs.

As shown, voltage sensors are depicted with voltage dividers and current sensors with shunt resistors and amplifiers, but numerous methods of sensing exist which may be adopted as appropriate. For example, the output current sensor (for current iₓ) utilizes a shunt resistor and a comparator, where the comparator provides a signal indicative of the direction of the current. Note that a current sense amplifier could be used rather than a comparator, from which the direction of the current could also be obtained. It may be advantageous to use a current sensor rather than a comparator since it could also be used for data collection, diagnostics, and/or telemetry. The current sensor could also be employed in an algorithm that analyzes the current for ripple, frequency, and/or other characteristics that could be used in an estimator or synchronization algorithm.

In this example, the output current sensor is shown coupled to a comparator (e.g., one form of an amplifier that saturates intentionally based on the sensed signal in comparison to threshold), suggesting that the direction of the current only may be used by the microcontroller unit 2502 for certain control algorithms implemented in the microcontroller software—though this should not taken to be limiting the output current to be based on comparison rather than its continuous value. Further, note that cables are depicted from the inputs and outputs of the solar-enabled hybrid converter unit 2500. In practice, these can be implemented with standard wiring appropriate for the task (commonly known as “PV Wire,” as one example). The connectors are depicted as conventional solar connectors, such as commercially available Staubli MC-4 connectors, or similar devices. Note that the microcontroller unit 2502 may be an embodiment, but the control function could also be implemented by a suitable analog and/or digital logic circuit. Such circuits can be implemented with discrete parts and/or with programmable logic devices, application-specific integrated circuits, and/or combinations thereof. In other words, the microcontroller unit 2502 can be substituted with other types of controller that are chosen to be optimal to meet design objectives.

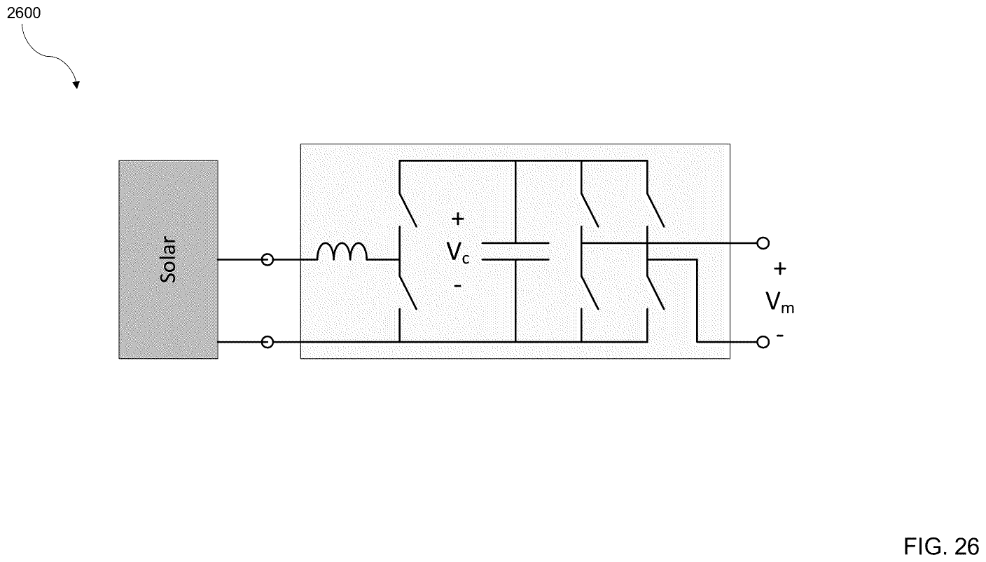

FIG. 26 illustrates another circuit diagram of an exemplary solar-enabled hybrid converter unit 2600. As shown in FIG. 26, the solar-enabled hybrid converter unit 2600 may represent one alternative version of a solar-enabled HCM. In some examples, the circuit includes a solar input port labeled “Solar” on the left side of the diagram, which is configured to receive power from a solar panel and/or other solar power generator. The solar input may connect to an inductor that couples to a switching network including two switches. This switching network may form a DC-DC converter that processes power from the solar input. Following the switching network may be a capacitor labeled “Vc” with positive and negative terminals, which serves as an energy storage element.

In some examples, the output section of the solar-enabled hybrid converter unit 2600 may include four switches arranged in an H-bridge configuration, rather than the two switches shown in some other embodiments. This four-switch version can provide an output voltage of substantially +Vc, −Vc, or 0V, offering greater flexibility by increasing the number of voltage levels and/or range of the aggregate voltage from the arms and/or legs. The output terminals are shown on the right side of the diagram. While this version requires more hardware than a two-switch implementation, it may provide considerable advantages in terms of output voltage control capabilities.

Variations implementations of the solar-enabled hybrid converter unit 2600 are possible. For example, the solar DC-DC converter shown in FIG. 26 may be implemented as a standard “boost” converter. In some example, the solar-enabled hybrid converter unit 2600 may include another power converter topologies. For example, the solar-enabled hybrid converter unit 2600 may include coupling a solar panel to a buck type converter. For example, the solar-enabled hybrid converter unit 2600 may include coupling a solar panel to switched capacitor converters, such as flying capacitor multilevel converters, which may be particularly advantageous in certain applications due to their high efficiency and power density characteristics. For example, the solar-enabled hybrid converter unit 2600 may include coupling a solar panel to a forward converter.

In some examples, the solar-enabled hybrid converter unit 2600 may include a hard, a soft switching, or a combination thereof. Even switched capacitor topologies may be advantageous in certain applications. Similarly, while FIG. 26 shows an “H-bridge” output configuration, numerous other implementations are conceivable, including various multi-level topologies that could further enhance the voltage control capabilities of the system.

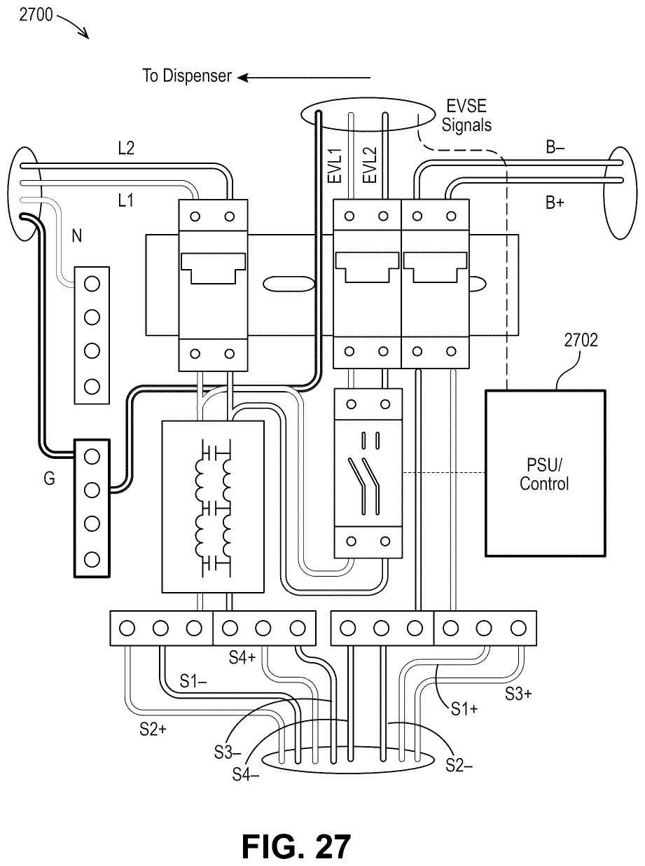

FIG. 27 illustrates a circuit diagram of an exemplary power combiner unit 2700 with EVSE signals. As shown in FIG. 27, the power combiner unit 2700 includes a control module 2702 labeled as “PSU/Control” that interfaces with multiple terminal connections. The diagram shows an alternate embodiment of a combiner with an additional circuit breaker and relay compared to the configuration described above. A control signal (shown as a dashed line) may couple the relay and the control module 2702, enabling them to perform the functions of electric vehicle safety equipment (EVSE). The terminal connections include wires labeled EVL1 and EVL2 that carry power to an EV “dispenser,” which is a device that couples an electric vehicle to a power source. The power combiner unit 2700 may be configured to function as a “Level-2” charger, which typically comprises a cable, J1772 connector, and/or safety circuitry including a switch (e.g., such as the two-pole relay shown). The relay in the power combiner unit 2700 may be closed or opened depending on various safety checks performed by the control module 2702, according to established standards. The control module 2702 may perform these safety checks based on measurements and/or signals received from the dispenser. This configuration may allow the power combiner unit 2700 to provide EV charging capability at low marginal cost compared to installing a separate charger. The control module 2702 can monitor load current and/or power to and from the EV to assist in managing battery capacity, net power export, and/or other variables. Additionally, the control module 2702 can limit the amount of current provided to the EV when advantageous, such as when solar and battery current are used for more critical loads and/or when energy consumption should be limited due to electricity prices.

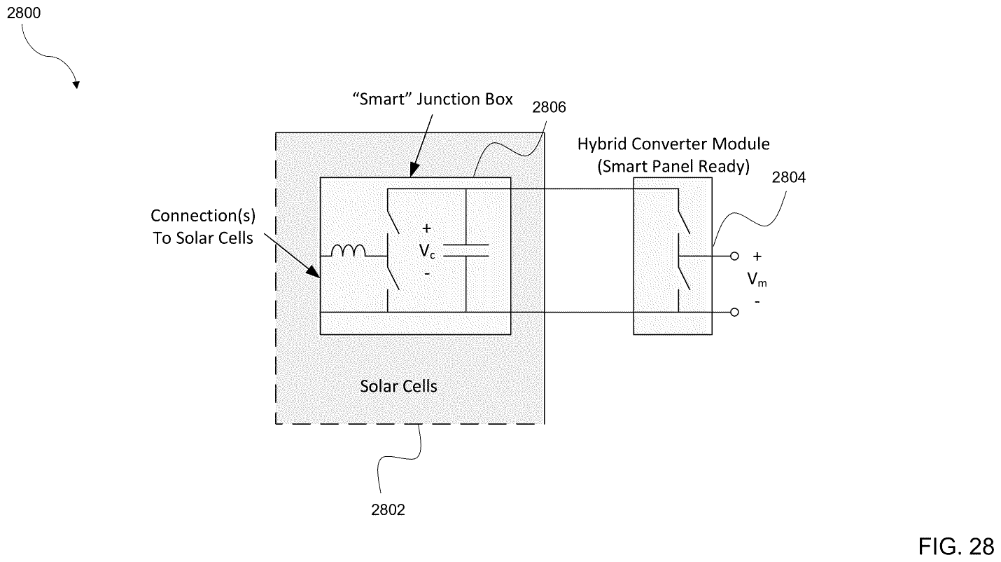

FIG. 28 illustrates a circuit diagram of an exemplary hybrid converter unit 2800 with a junction box 2802. As shown in FIG. 28, the hybrid converter unit 2800 includes a junction box 2802 including power conversion circuitry. The junction box 2802 includes an inductor and capacitor arrangement with positive and negative terminals marked as Vc. The junction box 2802 may be configured to connect to solar cells through connection points labeled “Connection(s) to Solar Cells” on the left side of the diagram. An output terminal 2804 may provide connectivity for the converted power output. The hybrid converter unit 2806 may be designated as “Smart Panel Ready” and connects to the junction box 2802.

In some examples, the hybrid converter unit 2800 may be adapted to be fully compatible with various smart-module technologies, up to and including the HCM itself being integrated with the solar panel (e.g., integrated into the junction box 2802 or as part of a junction box assembly). As shown in FIG. 28, a “smart panel” implementation is depicted that has a DC-DC boost converter encapsulated in the solar panel junction box 2802. This boost converter may behave as the solar DC-DC converter of the above-disclosed solar-enabled HCMs, with the output stage of the HCM separately enclosed in hybrid converter unit 2806. As shown in FIG. 28, a capacitor may be used as part of the junction box 2802, but could alternatively be located in the hybrid converter unit 2806, or divided in some proportion between the smart panel junction box 2802 and the hybrid converter unit 2806.

There are numerous ways to partition the circuitry of a solar-enabled HCM between the solar panel junction box 2802 and hybrid converter unit 2806. This may include the possibility that the entire HCM is integrated into the smart panel. In such cases, it is feasible that the HCM further includes bypass diodes, smart bypass diodes, and/or active balancing circuitry. The circuit may show the interconnections between the junction box 2802 and hybrid converter unit 2806, with power flow paths indicated by the connection lines. The junction box 2802 may process power from the solar cells through its internal components before passing to the hybrid converter unit 2806. The output terminal 2804 may provide the interface point for delivering the processed power to external circuits. The smart junction box 2802 may incorporate submodule and/or subpanel power optimization techniques. These may include differential power processing and/or power balancing methods to enhance overall system efficiency. Such optimization strategies can help mitigate the effects of partial shading or mismatch between solar cells.

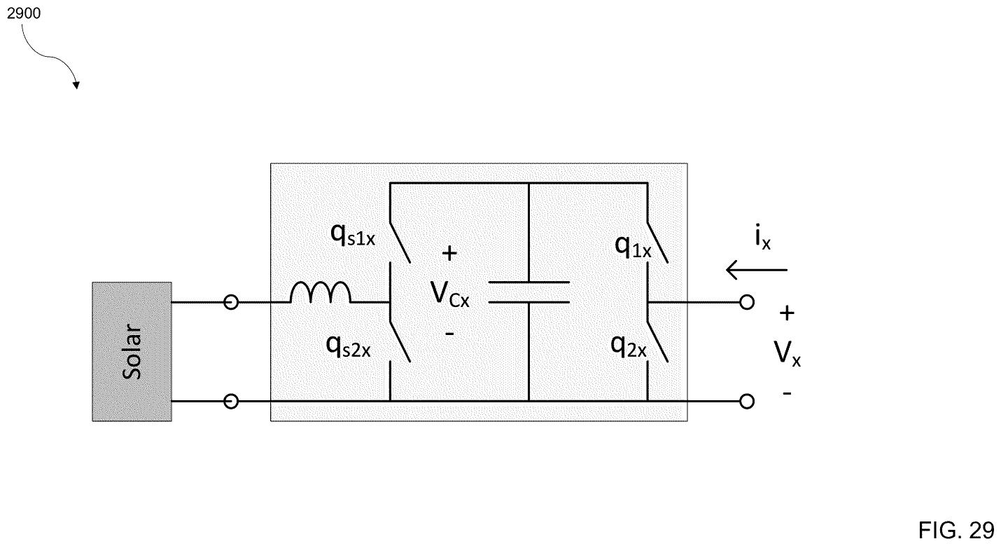

FIG. 29 illustrates a circuit diagram of an exemplary solar-enabled hybrid converter unit 2900 with switching elements. As shown in FIG. 29, The solar-enabled hybrid converter unit 2900 includes a solar port on the left side, which has switches qₛ₁ₓ and qₛ₂ₓ that can be operated as a DC-DC converter (e.g., a boost converter, as shown) to manage the flow of current from a solar panel. The switches may be connected to an inductor and/or a capacitor having a voltage Vcx. The output stage may include two switches labeled q₁ₓ and q₂ₓ arranged to control the output voltage. It is not necessary to have a solar panel or this DC-DC converter for the leg controller to operate; the solar DC-DC converter and solar panel may supplement the power flowing into the capacitor if available. Indeed, among N hybrid converter modules, less than N modules may be populated with a solar panel. In some examples, in the absence of sunlight, the solar panel may be effectively an open circuit (e.g., zero current). In some implementations, other DC-DC converters may be used instead of the boost converter as shown.

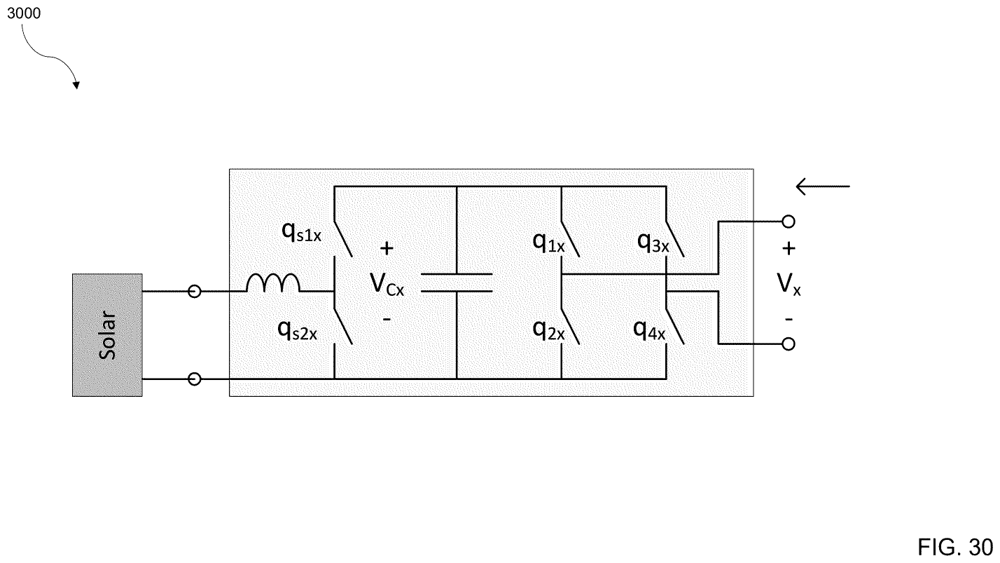

FIG. 30 illustrates another circuit diagram of an exemplary solar-enabled hybrid converter 3000 unit with multiple switches. As shown in FIG. 30, the solar-enabled hybrid converter unit 3000 includes a solar input port labeled “Solar” on the left side, which is configured to receive power from a solar panel and/or other solar power generator. The solar input may connect to a switching circuit comprising two switches labeled qₛ₁ₓ and qₛ₂ₓ that are coupled to an inductor. This switching arrangement may form a DC-DC converter that processes power from the solar input. A capacitor having a voltage Vcx may be positioned between the switching circuit and an output stage, serving as an energy storage element.

The output stage of the solar-enabled hybrid converter unit 3000 includes four switches labeled q₁ₓ, q₂ₓ, q₃ₓ and q₄ₓ arranged in an H-bridge configuration. These four switches can deliver substantially Vcx, −Vcx, or 0 volts to the output, depending on which of the four switches are turned on or off. For example, when switches q₁ₓ and q₄ₓ are on while q₂ₓ and q₃ₓ are off, the output voltage is +Vcx. The switches may be configured to selectively connect the capacitor voltage to output terminals marked with positive (+) and negative (−) polarities, shown on the right side of the diagram with an arrow indicating the signal flow direction.

The solar DC-DC converter portion of the solar-enabled hybrid converter unit 3000 may be similar to the configuration shown in FIG. 29, but the output stage differs by using four switches instead of two. This H-bridge configuration may provide additional flexibility in specifying a DC voltage source and potentially deliver a higher number of voltage levels to the leg output. It can also potentially take better advantage of the available DC voltage source and, therefore, use lower rated voltage devices for the power semiconductors and/or other components in the solar-enabled hybrid converter unit 3000. This configuration may have the disadvantage of increased complexity due to the additional switches.

FIG. 31 illustrates a block diagram of an exemplary modular energy conversion system 3100 with various components. As shown in FIG. 31, the system includes a solar panel array 3102 including multiple solar panels 3104, each connected to a corresponding hybrid converter module 3106. The hybrid converter modules 3106 may be electrically coupled to a power combiner unit 3108, which serves as a central hub for power management and distribution.

In some implementations, not all hybrid converter modules (HCMs) 3106 in the system may be connected to solar panels 3104. For example, some HCMs 3106 may be dedicated solely to battery energy storage and/or grid interface functions. This flexibility allows the modular energy conversion system 3100 to be customized for various applications, such as installations with limited roof space for solar panels 3104 or systems prioritizing energy storage capacity. The power combiner unit 3108 may be configured to manage and coordinate power flow between solar-connected HCMs 3106 and non-solar HCMs 3106. For example, the power combiner unit 3108 may regulate overall system performance based on available resources and energy demands.

In some examples, the power combiner unit 3108 may include several components, including a controller 3110, an EMI filter 3112, and/or a surge protector 3114. The controller 3110 may manage the overall operation of the system, coordinating power flow and/or optimizing energy conversion. The EMI filter 3112 may reduce electromagnetic interference, while the surge protector 3114 may safeguard the system against voltage spikes and/or transients.

In some examples, a battery system 3116 may be connected to the power combiner unit 3108, allowing for energy storage and/or bidirectional power flow. This configuration may enable the system to store excess solar energy and/or provide power during periods of low solar production and/or high demand.

In some examples, the power combiner unit 3108 may interface with a main service panel 3118, which may distribute power to various loads within a building and/or feed power back to the grid. The system may include connections to external devices and systems, enhancing its functionality and/or integration capabilities.

In this example, the controller 3110 is operably coupled to a communication tower 3120. For example, the communication tower 3120 may be connected to a communication network (e;g., the Internet, wireless/cellular connections (e.g., LTE)). For example, the controller 3110 may be connected to the 3120 through a home/business network (e.g., via WiFi or wired router connections). This may enable remote monitoring, control, and/or data exchange for the modular energy conversion system 3100, allowing for real-time system management and/or performance optimization.

In some examples, an electric vehicle 3122 may be included, which may support electric vehicle charging capabilities. This integration may allow for efficient use of solar energy for transportation needs.

In some examples, a mobile device 3124 may be included, which may offer user interface and/or control options through mobile applications. This feature may provide convenient access to system data and/or controls for end-users.

In some examples, the modular energy conversion system 3100 may be connected to an external power grid 3126. This connection may allow for bidirectional power flow, enabling the system to draw power from the grid and/or feed excess power back to the grid.

The arrangement of components in FIG. 31 may demonstrate the modular and scalable nature of the energy conversion system. The hybrid converter modules 3106 may process power from individual solar panels 3104, while the power combiner unit 3108 aggregates and/or manages the collective output. This architecture may allow for flexible system sizing and easy expansion by adding or removing solar panels and their associated hybrid converter modules.

The integration of multiple power sources (e.g., solar, battery, and/or grid) and loads through the power combiner unit 3108 may enable sophisticated power management strategies. The controller 3110 may optimize power flow based on factors such as solar availability, battery state of charge, grid conditions, and/or load demands.

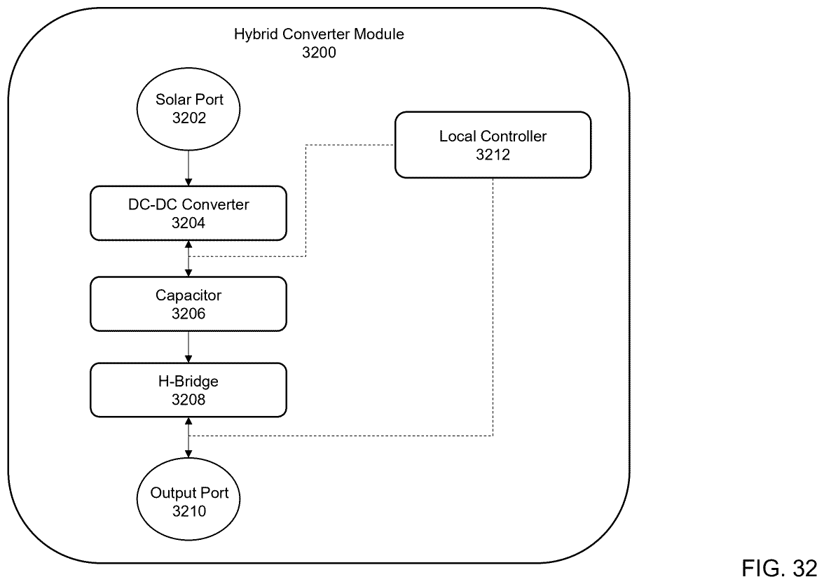

FIG. 32 illustrates a block diagram of an exemplary hybrid converter module 3200 with power conversion stages. As shown in FIG. 32, the hybrid converter module 3200 includes a solar port 3202, a DC-DC converter 3204, a capacitor 3206, an H-bridge 3208, an output port 3210, and a local controller 3212.

In some examples, the solar port 3202 may be configured to receive power input from a solar panel and/or other solar energy source. The solar port 3202 may be electrically connected to the DC-DC converter 3204, which may process the input power received from the solar port 3202. The DC-DC converter 3204 may adjust the voltage level of the input power to a suitable level for further processing within the hybrid converter module 3200.

In some examples, the DC-DC converter 3204 may be connected to the capacitor 3206, which may serve as an energy storage element and help stabilize the voltage within the hybrid converter module 3200. The capacitor 3206 may be connected to the H-bridge 3208, which may convert the DC power from the capacitor 3206 into AC power and/or a different DC voltage level.

In some examples, the H-bridge 3208 may be connected to the output port 3210, which may provide the processed power output from the hybrid converter module 3200. The output port 3210 may interface with other components in the modular energy conversion system, such as other hybrid converter modules and/or a power combiner unit. In some implementations, the H-bridge 3208 may be replaced with a simpler two-switch configuration, as discussed herein. The two-switch version may be suitable for applications where bipolar output voltage is not used or where the additional flexibility of the four-switch H-bridge is not useful. The two switches may be controlled to selectively connect the capacitor voltage to the output port 3210, allowing for unipolar voltage output.

In some examples, a local controller 3212 may be connected to both the DC-DC converter 3204 and the H-bridge 3208 through control signal paths. The local controller 3212 may manage the operation of these components, potentially implementing control algorithms such as maximum power point tracking for solar input and/or output voltage regulation.

The arrangement of components within the hybrid converter module 3200 may allow for flexible power conversion and/or control. For example, the DC-DC converter 3204 may optimize power extraction from the solar input, while the H-bridge 3208 may enable the module to produce various output voltage waveforms as used by the overall system.

In some examples, multiple hybrid converter modules 3200 may be connected in series or parallel configurations to form larger power conversion arrays. The modular nature of the hybrid converter module 3200 may allow for scalable system designs that can be adapted to various power requirements and/or solar array sizes.

In some examples, the local controller 3212 may communicate with external system controllers and/or other hybrid converter modules to coordinate operations within a larger energy conversion system. This distributed control architecture may enable efficient power management and/or fault tolerance in the overall system.

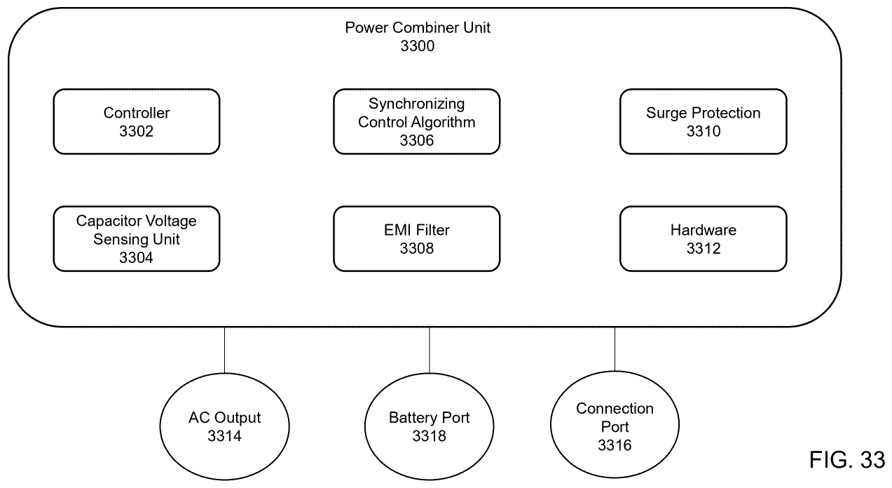

FIG. 33 illustrates a block diagram of an exemplary power combiner unit 3300 with control and protection components. As shown in FIG. 33, the power combiner unit 3300 includes several components that work together to manage and/or control power flow in the modular energy conversion system. For example, the power combiner system 106 may include the power combiner unit 3300.

In some examples, the power combiner unit 3300 may include a controller 3302. This controller may be responsible for coordinating the overall operation of the power combiner unit and may interface with other system components. The controller 3302 may execute algorithms for power management, system monitoring, and/or communication with external devices.

In some examples, connected to the controller 3302 may be a capacitor voltage sensing unit 3304. This unit may be configured to monitor and/or measure the voltages across capacitors in the hybrid converter modules. The capacitor voltage sensing unit 3304 may provide feedback to the controller 3302, allowing for real-time adjustments in power conversion strategies.

In some examples, the power combiner unit 3300 may incorporate a synchronizing control algorithm 3306. This algorithm may be implemented within the controller 3302 and/or as a separate module. The synchronizing control algorithm 3306 may ensure that the outputs from multiple hybrid converter modules are properly coordinated and synchronized, which may be used for efficient power combining and/or conversion.

In some examples, an EMI filter 3308 may be included in the power combiner unit 3300. This filter may help reduce electromagnetic interference generated by the switching operations within the system. The EMI filter 3308 may improve the overall power quality and ensure compliance with relevant electromagnetic compatibility standards.

In some examples, adjacent to the EMI filter 3308 may be a surge protection component 3310. This component may safeguard the power combiner unit 3300 and connected devices from voltage spikes and/or transients that could potentially damage sensitive electronic components.

In some examples, the power combiner unit 3300 may include hardware 3312, which may encompass various physical components used for the unit's operation. This hardware may include circuit boards, connectors, and/or other supporting structures. In some examples, the power combiner unit 3300 may incorporate various sensors to monitor critical system parameters. These sensors may include voltage sensors, current sensors, temperature sensors, and potentially other types of sensors to measure quantities such as power factor, frequency, and/or environmental conditions, providing comprehensive data for system monitoring and control.

In some examples, an AC output 3314 may be connected to the unit and may indicate where the combined and processed power exits the unit. This output may connect to the main service panel and/or other loads in the system.

In some examples, a connection port 3316 may serve as an interface for external communications and/or additional system components. This port may allow for system expansion, monitoring, and/or integration with other smart home and/or energy management systems. The power combiner unit 3300 may include a battery port 3318 for connecting one or more energy storage devices. This battery port 3318 may enable the integration of various types of batteries, allowing for flexible energy storage options and enhanced system capabilities.

The connection port 3316 may, in some implementations, include a hybrid converter arm interface (HCAI). For example, the HCAI may transmit power, control signals, communication signals, or a combination thereof, to the hybrid converter arms (e.g., anyone or more of the hybrid converter arms 112, 114, 116, 118). For example, the HCAI may enable bidirectional power flow between the power combiner unit 3300 and the hybrid converter modules, while simultaneously allowing for data exchange to coordinate operations and monitor performance across the system.

The arrangement of these components within the power combiner unit 3300 may allow for efficient power management, conversion, and/and distribution. The controller 3302 may receive inputs from the capacitor voltage sensing unit 3304 and use the synchronizing control algorithm 3306 to coordinate the operation of multiple hybrid converter modules. The processed power may then pass through the EMI filter 3308 and surge protection 3310 before being output as AC power through the AC output 3314.

This configuration may enable the power combiner unit 3300 to adapt to varying input conditions from solar panels and/or battery systems, while maintaining stable and high-quality power output. The modular nature of the system, as represented by the connection port 3316, may allow for future expansions and/or upgrades to the energy conversion system.

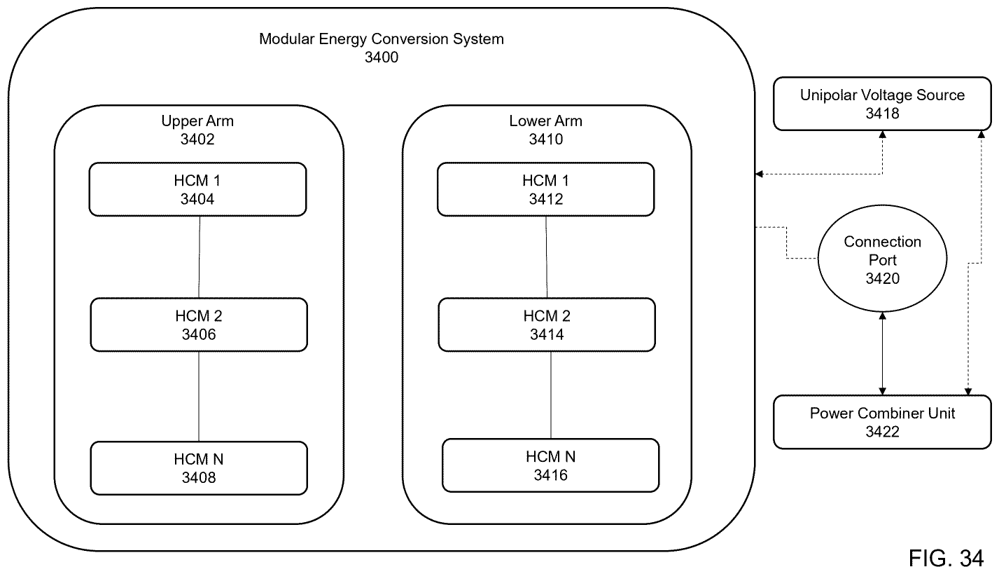

FIG. 34 illustrates a block diagram of an exemplary modular energy conversion system 3400 with upper and lower arms. As shown in FIG. 34, the modular energy conversion system 3400 includes an upper arm 3402 and a lower arm 3410, each comprising multiple hybrid converter modules (HCMs) connected in series.

In some examples, the upper arm 3402 may include HCM 1 3404, HCM 2 3406, and HCM N 3408, where N represents the total number of HCMs in the arm. Similarly, the lower arm 3410 may include HCM 1 3412, HCM 2 3414, and HCM N 3416. This configuration may allow for scalability, as the number of HCMs in each arm may be adjusted based on system requirements.

In some examples, a unipolar voltage source 3418 may be electrically connected to both the upper arm 3402 and the lower arm 3410. This unipolar voltage source 3418 may provide DC power to the system, which can be converted and processed by the HCMs in each arm.

In some examples, the upper arm 3402 and lower arm 3410 may be connected at a common point, forming a connection port 3420. This connection port 3420 may serve as an interface between the HCM arms and other system components.

In some examples, a power combiner unit 3422 may be electrically connected to the connection port 3420. The power combiner unit 3422 may be responsible for aggregating and/or managing the power processed by the HCMs in both arms. It may coordinate the operation of the HCMs to achieve desired power flow and/or voltage levels.

In some examples, in operation, the modular energy conversion system 3400 may convert DC power from the unipolar voltage source 3418 into AC power and/or modified DC power through the coordinated switching of the HCMs in the upper and lower arms. The power combiner unit 3422 may regulate the overall system output based on feedback from the HCMs and other system parameters.

This modular architecture may allow for flexible system design and/or scalability. Additional HCMs may be added to each arm to increase power handling capacity and/or voltage levels. The system may be adapted for various applications by modifying the control algorithms in the power combiner unit 3422 and individual HCMs.

In some examples, the modular energy conversion system 3400 may be used in various renewable energy applications, such as solar power systems, where it can efficiently convert and/or manage power from multiple sources. The system's modular nature may enhance reliability through redundancy and/or allow for easier maintenance by enabling the replacement of individual HCMs without disrupting the entire system.

FIG. 35 illustrates a block diagram of an exemplary output current control system 3500. As shown in FIG. 35, a control system 3500 for regulating output current in a modular energy conversion system may implement an output current control architecture suitable for a single-leg apparatus configuration. As shown in FIG. 35, an output current command signal (iₒᵤₜ*) is provided as an input to the system. This command signal may represent the desired current that should flow through the AC load or from the AC source. The measured output current (iₒᵤₜₘₑₐₛ) may be subtracted from the output current command at a first summation node, generating an output current error signal.

The output current error signal may then be processed through a proportional-integral (PI) controller block. While a PI controller is illustrated in the exemplary embodiment, those skilled in the art will recognize that various types of current controllers and/or gain blocks could be implemented to achieve similar control functionality. For example, a proportional (P) controller may be used in applications where fast and simple response is desired, offering low implementation complexity. For example, a proportional-derivative (PD) controller may be used when improved stability and damping of transient responses are required. For example, a proportional-integral-derivative (PID) controller may advantageously be used in application requiring fast response and zero steady-state error. In various examples, the PI controller may advantageously provide dynamic compensation of the error signal, applying both proportional and integral gains to generate an appropriate control response.

The output from the PI controller may then be passed to a second summation node, where it is combined with a nominal output voltage signal (Vₒᵤₜₙₒₘ). This nominal output voltage signal may represent either an intended voltage across an AC load or an expected voltage across an AC source. For example, in a typical split-phase residential power system, Vₒᵤₜₙₒₘ may be represented as 240√2 sin(θ), where θ is an angle representing the phase of the substantially sinusoidal power grid. For a fixed frequency system, θ=2πft+φ, where f=60 Hz, t is time, and φ is a constant phase shift angle.

In some examples, the frequency and/or phase shift of the power grid may vary, and can be detected using established methods such as a phase-locked loop (PLL). Therefore, when interfacing with an AC source, the nominal output voltage signal may rely on a PLL and/or other detection mechanism to generate the angle θ. When powering an AC load, the system may either assume a constant frequency and phase shift or deliberately vary either parameter as used by the application.

In some examples, including the nominal output voltage signal may provide a feedforward component to the control system 3500, improving its dynamic response. Similarly, the output current command (iₒᵤₜ*) may typically be a sinusoidal signal in phase with the output voltage, having an amplitude and phase shift selected to deliver the desired amount of real and reactive power. While sinusoidal waveforms are typical, the output current command may not have to be perfectly sinusoidal for all applications.

The combined signal from the second summation node passes through a scaling block labeled “1” in this single-leg configuration. The output of this scaling block may be the leg command voltage (V_{LEG}*) that is subsequently passed to the leg controller for implementation. This leg command voltage may direct the switching operations of the hybrid converter modules to generate the appropriate voltage waveform at the connection point, ultimately producing the desired current through the AC load and/or from the AC source.

The control system 3500 may provide a feedback control structure where the measured output current is continuously compared against the commanded current, with the resulting error signal driving appropriate control actions through the PI controller and subsequent processing stages. This control architecture may enable precise regulation of the output current in the modular energy conversion system.

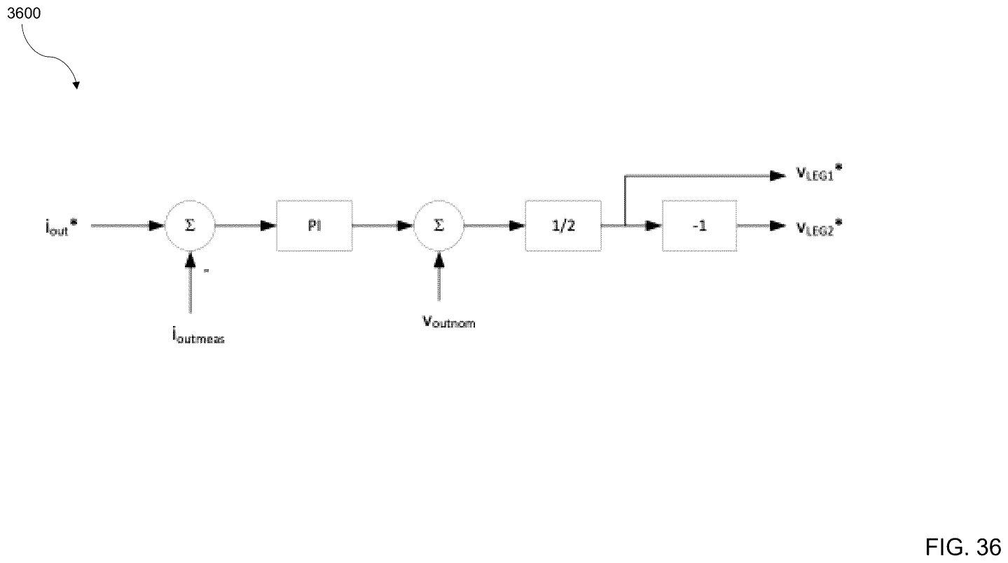

FIG. 36 illustrates another block diagram of an exemplary control system 3600 for power conversion. As shown in FIG. 36, a control system 3600 for processing input signals in a power conversion application may be depicted. The control system 3600 may represent an AC voltage signal generator appropriate for a two-leg apparatus configuration. The control system 3600 may receive an input signal labeled “iₒᵤₜ*” which represents an output current command. This command signal may be compared with a measured output current signal “iₒᵤₜₘₑₐₛ” at a first summation node. The difference between these signals, representing the output current error, may pass through a proportional-integral (PI) control block.

In some examples, the output from the PI block may connect to a second summation node where it combines with a nominal output voltage signal labeled “Vₒᵤₜₙₒₘ”. This nominal output voltage signal may represent an intended voltage across an AC load and/or an expected voltage across an AC source. For example, in a typical split-phase residential power system, Vₒᵤₜₙₒₘ may equal 240√2 sin(θ), where θ is an angle representing the phase of the substantially sinusoidal power grid. For a fixed frequency system, θ=2πft+φ, where f=60 Hz, t is time, and φ may be a constant phase shift angle.

In some examples, the frequency and/or phase shift of the power grid may vary somewhat and can be detected using established methods such as a phase-locked loop. Therefore, when interfacing with an AC source, the nominal output voltage signal may rely on a phase-locked loop and/or other detection mechanism to generate the angle θ. When powering an AC load, the system may either assume a constant frequency and phase shift or deliberately vary either parameter as used by the application. Including the nominal output voltage signal may provide a feedforward component to the control system 3600.

The combined signal from the second summation node may then pass through a scaling block with a factor of ½. This scaling factor of ½ may be used because the two-leg configuration has the effect of providing twice the AC voltage across the AC source and/or AC load, as the connection point of each leg is driven in opposition. The output of this scaling block may provide the leg command voltage (V_{LEG}*) that is subsequently passed to the leg controller for implementation. The control system 3600 may generate two signals, one for each of two legs (V_{LEG1}* and V_{LEG2}*), with V_{LEG1}* being the negative of V_{LEG2}*. This approach may drive the legs in opposition to achieve the desired voltage across the AC load and/or from the AC source.

In some examples, the control system 3600 may provide a feedback control structure where the measured output current is continuously compared against the commanded current, with the resulting error signal driving appropriate control actions through the PI controller and subsequent processing stages.

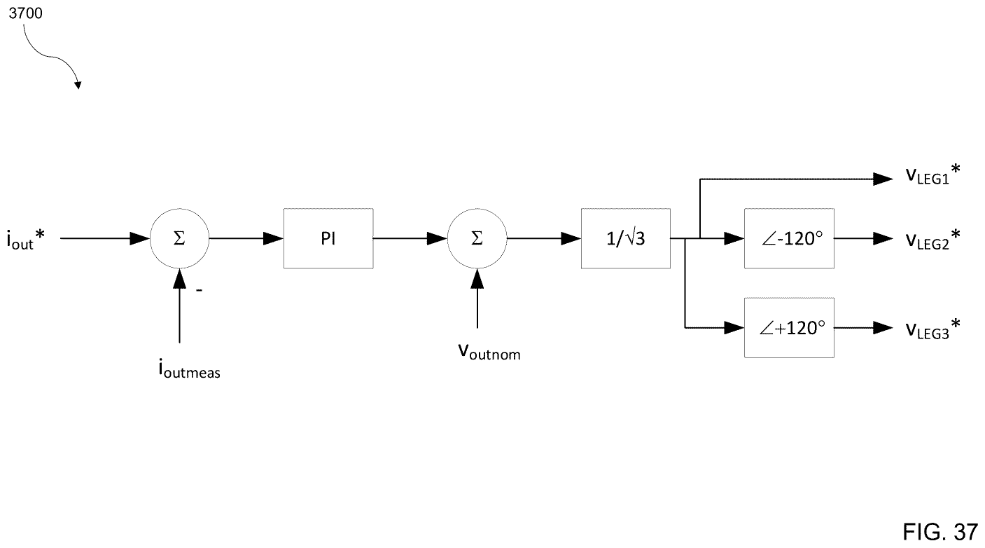

FIG. 37 illustrates a block diagram of an exemplary three-phase control system 3700 for power conversion. As shown in FIG. 37, the control system 3700 may receive an input signal labeled “iₒᵤₜ*” which represents an output current command. This command signal may be compared with a measured output current signal “iₒᵤₜₘₑₐₛ” at a first summation node. The difference between these signals, representing the output current error, may pass through a proportional-integral (PI) control block that provides dynamic compensation.

The output from the PI block may connect to a second summation node where it combines with a nominal output voltage signal labeled “Vₒᵤₜₙₒₘ”. This nominal output voltage signal represents an intended voltage across an AC load and/or an expected voltage across an AC source. The combined signal may pass through a scaling block labeled “1/√3” before reaching a branching point where the signal splits into three separate paths.

Each path may include a phase shift block, with the three blocks labeled “−120°”, “0”, and “+120°” respectively. These phase shift blocks may generate three voltage command signals that are offset by 120 degrees from each other, corresponding to the three phases of a balanced three-phase system. The outputs from these phase shift blocks may provide three leg command voltage signals labeled V_{LEG1}*, V_{LEG2}*, and V_{LEG3}*.

This configuration may be designed to drive each of three legs for a system. The scaling factor of 1/√3 may be provided to appropriately scale the voltage commands for three-phase operation. This approach may assume a single output current command is provided, from which three leg voltage commands are generated, even though there are actually three output currents in a three-phase system. In some examples, there may be three separate current commands that are phase shifted 120 degrees apart, and use a diagram similar to FIG. 35, but with the 1/√3 scaling factor. In the case of a wye-connected configuration, the three output currents may sum to zero, which may be considered in specifying the three-phase output current commands. In various implementations, other configurations may be implemented to generate leg command voltage for various load and source configurations and numbers of phases, including unbalanced and/or asymmetric conditions.

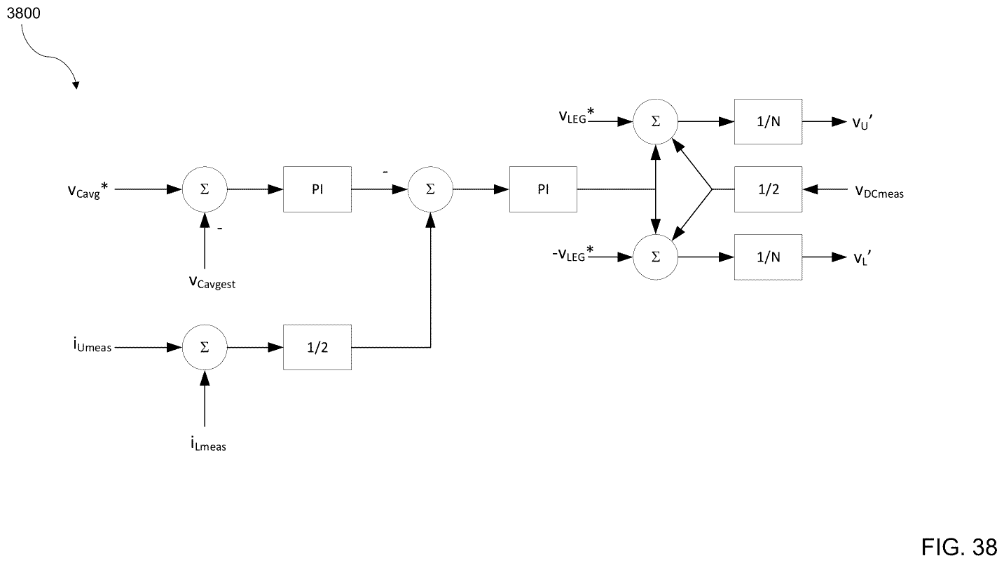

FIG. 38 illustrates a block diagram of an exemplary control system 3800 with multiple signal processing blocks. As shown in FIG. 38, a control system 3800 is configured for a modular multilevel converter. The control system may receive a leg voltage command, V_{LEG}*, as shown, as well as a commanded average capacitor voltage, V_{Cavg}*, which represents a target for the average of the capacitor voltages, v_{CUx} and v_{CLx}, for all x from 1-N, in the HCMs in the leg. The leg controller may receive an estimate of the average of the capacitor voltages, V_{Cavgest}, which will be explained further below. Measurements of the two arm currents, i_{U} and I_{L}, which are i_{Umeas} and i_{Lmeas}, respectively, may be provided to the leg controller. In addition, V_{DCmeas}, a measurement of the DC source voltage, v_{DC}, may be provided to the leg controller.

An error between V_{Cavg}* and V_{Cavgest} may be calculated and passed to the average voltage gain block as shown, which is depicted (for sake of example) as a proportional-integral (PI) control block. In addition, the upper (i_{Umeas}) and lower (i_{Lmeas}) arm current measurements may be averaged. The arm currents may cause the HCM capacitors to charge or discharge, depending on the magnitude and direction of the current in either arm. The difference in arm currents may result in the leg output current from the leg connection point. The average (e.g., proportional to sum) may affect the overall charging and discharge of the average of the capacitor voltages.

The average capacitor gain block output may be subtracted from the average arm current measurement to produce another error signal, which may aid in achieving arm currents that will ultimately result in the average capacitor voltages in check. This error signal may be passed to another gain block, which we will term the leg voltage adjustment gain block and is (for the sake of example), also depicted as a PI gain block. The output of the leg voltage adjustment gain block may contribute to calculations of two signals, v_{U}′ and v_{L}′, which represent adjusted voltage signals for the upper and lower arm HCMs, respectively. Note that these signals may be scaled by 1/N, with N being the number of HCMs present in each of the upper and lower blocks, respectively. This scaling by 1/N may account for division of voltage that occurs across the series-connected HCMs. Furthermore, the measured DC voltage, V_{DCmeas}, may be used to offset the adjusted voltage signals by half of the DC voltage, as shown. This accounts for the shift of the leg connection point to ideally be half of the DC voltage. The two adjusted voltage signals may differ in whether V_{LEG}* is added or subtracted from the final sum. This may be due to the upper arm and lower arm being either above or below the leg connection point, respectively, in terms of how the HCMs affect the voltage at the leg connection point.

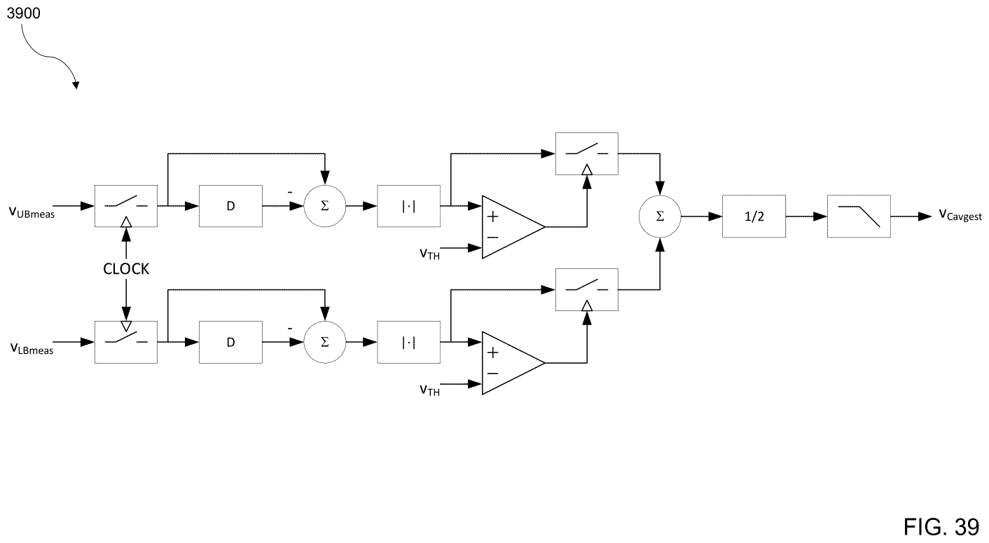

FIG. 39 illustrates a block diagram of an exemplary control system 3900 for regulating output voltage and current. As shown in FIG. 39, a block diagram of a control system 3900 for an average capacitor voltage estimator is demonstrated. The control system 3900 may enable remote measurement of capacitor voltages without requiring high-speed communication between the power combiner unit and individual hybrid converter modules (HCMs). The upper and lower block voltage measurements, V_{UBmeas} and V_{LBmeas}, respectively, may be fed to the control system 3900. These measurements may be taken at connection points where the HCM blocks are wired to a combiner and/or other suitable enclosure including inductors, sensors, protection devices, and/or other components. By collocating the core controller with these connections, direct measurement of the block voltages may be enabled.

The control system 3900 may include two parallel processing paths, each including a sampler followed by a delay element (D). When an HCM changes switching state, its output voltage (v_{Ux} or V_{Lx}) steps by an amount substantially equal to the HCM's capacitor voltage (v_{Cx}), causing the block voltage to exhibit a waveform with numerous step voltages. Each block voltage may be sampled at a sufficiently high frequency to capture edge transitions between successive samples. The system may subtract the current sample from the past sample using the delay element, with the absolute value of this difference yielding the magnitude of the voltage change.

If this change exceeds a threshold, the comparator in the control system 3900 may trigger another sampler to capture the current sampled magnitude of the block voltage difference. This process may capture a succession of changes in block voltage, each change being induced by the various switching actions of the HCMs in the block. Each of these changes may approximately equal one of the HCM capacitor voltages. As long as all HCMs are regularly switching, the control system 3900 may cycle through all the HCM capacitor voltages.

This process may occur in parallel for both blocks in the leg, one for each of two arms. The outputs of the samplers may be combined at a multiplication/averaging block as shown in the control system 3900. This may result in a waveform that iterates and/or cycles (e.g., perhaps with an irregular pattern) through all the HCM capacitor voltages in the leg. To smooth this potentially jagged waveform, a low-pass filter may be applied at the output stage of the control system 3900. As a result, the final estimate, V_{Cavgest}, may provide an approximation of the average of all the HCM capacitor voltages without the need to measure and/or communicate the voltages individually from the HCM to the core controller.

While FIG. 39 illustrates one possible implementation of the control system, it may be understood that alternative configurations are possible. In some examples, the capacitor voltages may be communicated back to the power combiner unit via a dedicated communication line. However, the method depicted in FIG. 39 may offer advantages by reducing the overall communication burden on the system. By estimating the average capacitor voltage without requiring individual voltage measurements to be transmitted, the control system 3900 may minimize the need for high-speed data transfer between the hybrid converter modules and the power combiner unit. This approach may be particularly beneficial in systems with a large number of HCMs, where the volume of voltage data to be communicated could otherwise be substantial.

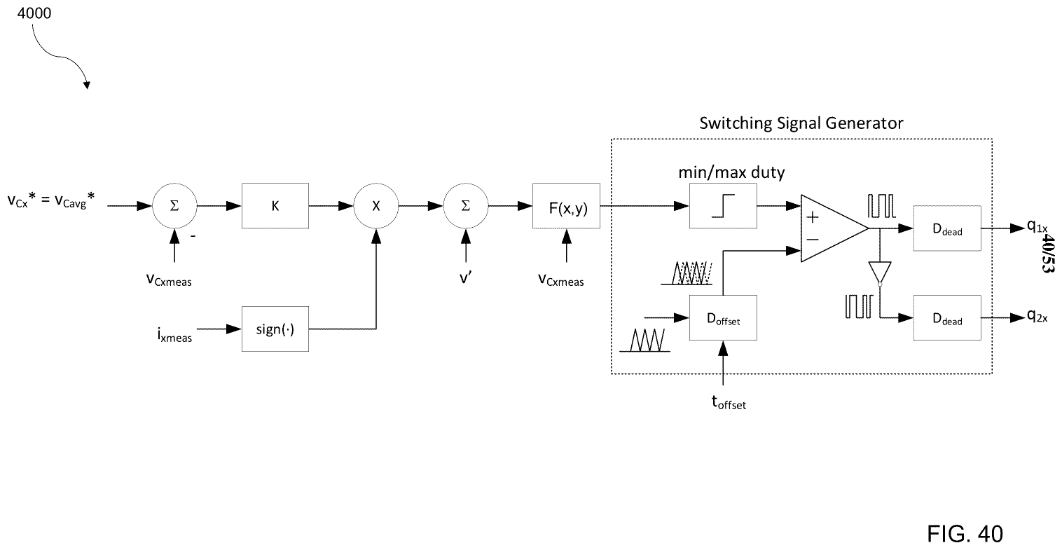

FIG. 40 illustrates a block diagram of an exemplary control system 4000 for processing signals in power conversion. The control system may be instantiated in each HCM, numbered x=L1-LB or x=U1-UN. Voltage v_{Cx}*, which will be substantially or exactly equal to the average capacitor voltage command. The capacitor voltage command may be preprogrammed into the HCM output controller, or may be updated if and when the average capacitor voltage command changes. In any case, the capacitor voltage measurement, V_{Cxmeas}, may be subtracted from v_{Cx}* to produce a capacitor voltage error. This error may be scaled by a constant, K, to produce a scaled capacitor voltage error signal. Note that a more sophisticated gain block could be used, other than a constant, but a constant can also be sufficient for many cases. The scaled error signal may be multiplied by the algebraic sign of the output current, iₓ, which can flip the sign of the scaled error signal. This sign changing feature may have the effect of increasing or decreasing the duty cycle of the output switches (q₁ₓ, q₂ₓ) such that more or less of the current iₓ is steered into the capacitor.

As such, the capacitor voltage can be regulated towards its commanded target based on how much current is flowing in either direction. The resulting signal may be added to the signal v′, which may be either v_{U}′ or v_{L}′, depending on whether the HCM is located in the upper (U) and lower (L) arm. In some implementations, the resulting signal may associate with a desired output voltage for the HCM, vₓ*, the intended value for vₓ. This signal may be passed into a function (f(x,y) as shown in FIG. 40) that will generate a duty cycle command based on the voltage command and the measured capacitor voltage for the full bridge stage. For example, the function may be a simple division (e.g., x/y as described in FIG. 39). In some examples (e.g., for full-bridge control), the function may include a more complex function (e.g., k*(a+x/y), 0.5(1+x/y)) to, for example, properly center and scale the duty cycle. In this example, the resulting duty cycle command may then be passed through a clamping block to limit the minimum and maximum duty cycle values. For example, duty cycles can inherently only range between 0 and 1. In some examples, the control system 4000 may clamp the duty cycle to a narrower range (e.g., 0.02-0.98, other suitable limits known to those skilled in the art).

The clamped duty cycle command may then be provided to a switching signal generator that uses a triangle wave and comparator to generate pulses that can be fed gate drive circuits (not shown) to drive the output switches. The pulses, which are effectively pulse-width modulated, may also pass through a deadtime delay block, which shortens the pulses slightly such that both switches are not turned on at the same time, which can occur in practice due to power semiconductors not being ideal and taking time to transition from on to off and off to on. Note that there are numerous methods to generate switch signals, only one representation is shown here based on analog comparison of a signal compared to a triangle wave, including numerous digital methods which are well known in the art.

The output from the gain block may then be multiplied at a multiplication node marked “X” with the algebraic sign of the output current imeas, which is determined by the sign block labeled “sign(θ)”. This sign-changing feature may effectively increase or decrease the duty cycle of the output switches based on current direction, steering more or less current into the capacitor to regulate its voltage toward the commanded target. The resulting signal may then be added to a voltage signal Vφ at another summation node “S”, which may represent either vU′ or vL′ depending on whether the hybrid converter module is located in the upper or lower arm.

As shown in FIG. 40, a delay offset is depicted, such that a commanded time offset, t_{offset}, can be used to time shift the triangle wave (e.g., or effectively, the center point or edges of the switching signals) by a given amount of time. It may be advantageous for each HCM to have a different relative offset such that not all the HCMs are switching simultaneously, as is known in the art. That is, the HCMs can be staggered to reduce the voltage and current harmonics in the leg voltage and current waveforms

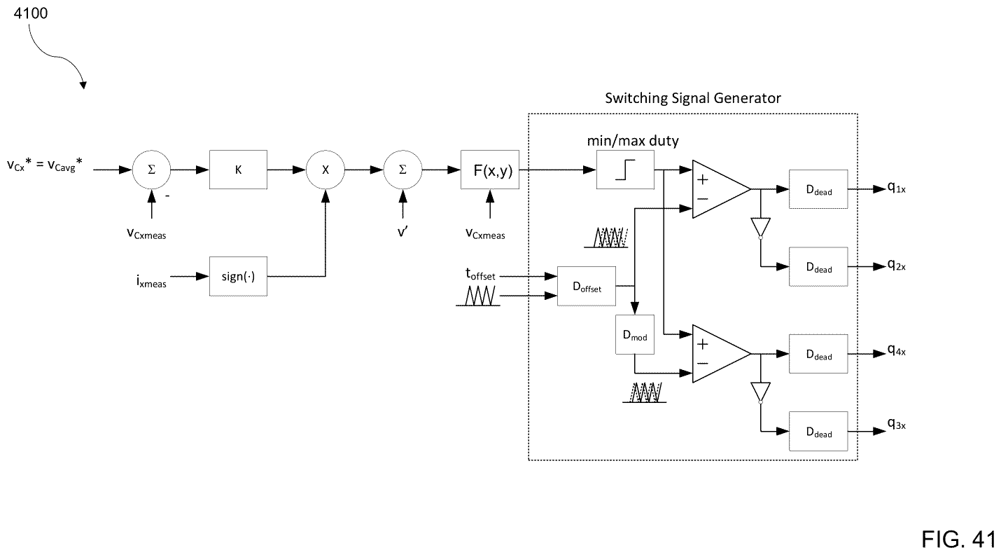

FIG. 41 illustrates a block diagram of an exemplary control system 4100 for regulating power conversion in a modular energy system. As shown in FIG. 41, the control system 4100 implements a sophisticated control architecture for the hybrid converter module output controller. As shown in the diagram, the control system 4100 includes multiple signal processing stages arranged in a hierarchical configuration to process voltage and current signals through various mathematical operations. The HCM output controller causes the output switches to be modulated such that a desired leg voltage is obtained while maintaining the HCM capacitor voltage at or near its commanded value. The control system 4100 includes several summing junctions connected by signal paths, with processing blocks interspersed between them to perform proportional-integral control and other signal conditioning functions.

The control system 4100 can be modified to accommodate four output switches, similar to the configuration shown in FIG. 39. This modification may include a modulation delay that may be applied to one pair of switches such that both the duty cycle of the switches and the relative time shift between them can be varied to deliver a more nuanced output voltage, vₓ. While not explicitly shown in the diagram, there may also be provisions to disable the modulation of one pair of switches. For example, switches 1 and 2 may be modulated while switch 3 is open and switch 4 is closed. This has the effect of toggling vₓ between v_{Cx} and 0, instead of v_{Cx} and −v_{Cx}, which could have significant impacts on noise characteristics, harmonic content, and overall system performance.

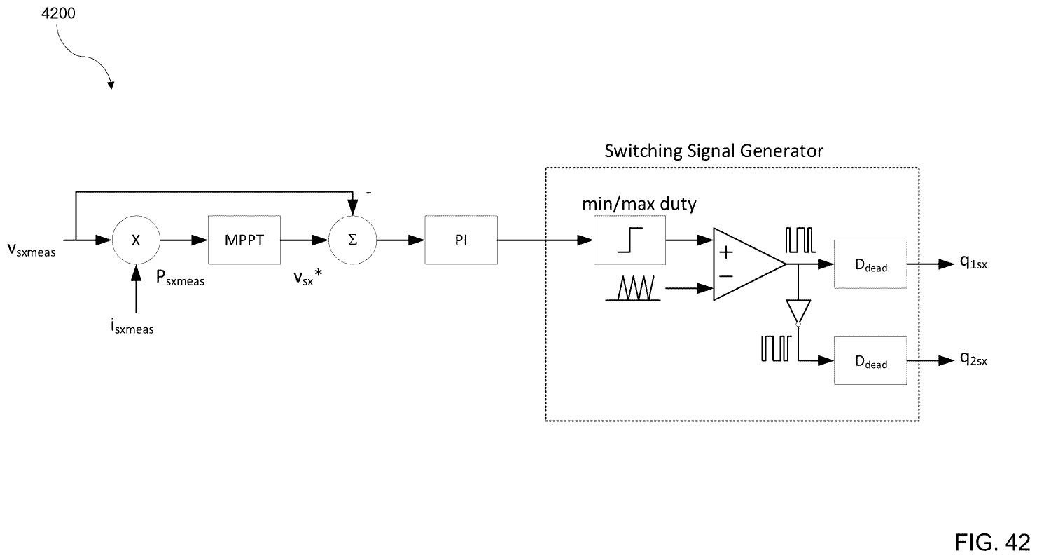

FIG. 42 illustrates a block diagram of an exemplary control system for maximum power point tracking. Referring now to FIG. 42, a control system 4200 for maximum power point tracking (MPPT) in a power conversion system is illustrated. The control system 4200 includes a multiplication block that receives voltage (Vₛₓₘₑₐₛ) and current (iₛₓₘₑₐₛ) measurements from the solar input as inputs. These measurements may be multiplied to provide a measured solar power (Pₛₓₘₑₐₛ). This measured power may pass to a maximum power point tracker (MPPT) block, which, based on current and possibly previous values of Pₛₓₘₑₐₛ, provides a commanded solar input voltage (Vₛₓ*). The MPPT block may also rely on current or previous measurements or commands for voltage and/or current from the solar input. There are numerous MPPT algorithms known in the literature, many of which may be readily adapted to this application.

The commanded solar input voltage (Vₛₓ*) may be compared with the measured solar input voltage at a summation node to produce a solar input voltage error. This error may be passed to a solar voltage controller block, which is depicted as a proportional-integral (PI) controller. The output of the PI controller may connect to a switching signal generator that produces complementary pulse signals through two parallel paths.

The switching signal generator may include a min/max duty cycle limiter and generate two output signals labeled q₁ₛₓ and q₂ₛₓ. Each output path may include a deadtime block (Ddead) to prevent simultaneous switching of the output signals, which could otherwise cause short circuits in the power stage. The switching signals may be provided to gate drive circuits (not shown) to drive the corresponding switches in the hybrid converter module.

In some examples, the control system 4200 may be augmented with additional features that may be useful. For example, there may be situations where it is advantageous to turn off or bypass the MPPT block, which could be useful if the solar panel is providing more power than can be currently utilized by the HCM. If the capacitor voltage, v_{Cx}, for example, is rising up to an unacceptable level, it may be beneficial to disable the MPPT block such that the capacitor voltage can return to a normal level more quickly. It may also be useful to cap the amount of power from the solar panel under some circumstances. Such a case could occur when the overall system may be producing more power than the load (or even battery charging) can beneficially use. This could be particularly the case if the battery is fully (e.g., or nearly fully) charged and the solar panels alone are powering the AC load or AC source.

The controller topology depicted in FIG. 42 can be implemented as analog and/or digital circuits. Further, at least some of the aspects of the controller can be implemented in software on a computer such as a microcontroller/microcomputer and/or in configurable hardware such as programmable logic device or field programmable gate array. Blocks depicted as analog blocks, such as the PI controller, are well understood to have digital/discrete counterparts that can be implemented readily in software or programmable logic. Any such circuits can be supplemented with sensors, analog-to-digital or digital-to-analog converters, clocks, and other hardware necessary to implement the controller according to known methods.

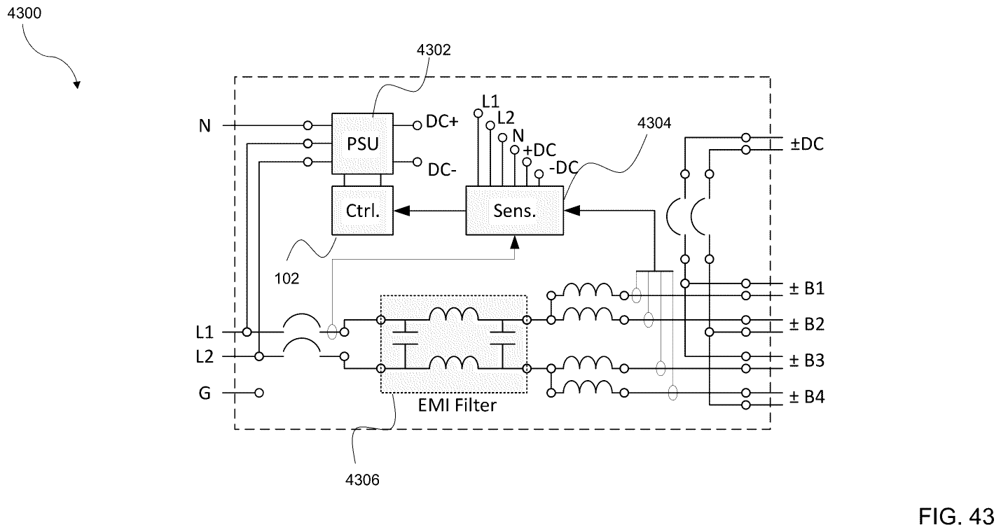

FIG. 43 illustrates a block diagram of an exemplary power conversion system 4300 (e.g., power combiner system 106) for residential applications. As shown in FIG. 43, the power conversion system 4300 includes a power supply unit (PSU) 4302 that couples to both AC power inputs (labeled L1, L2, N, and G) and DC voltage sources. For example, the PSU 4302 may include the RCU 108. The PSU 4302 may generate multiple supply voltages, such as +24V, +3.3V, +5V, and potentially others, which may be utilized by various circuits within the system. The power conversion system 4300 further includes a sensing circuit 4304 and a control circuit (Ctrl.) that may be powered by the PSU 4302. Collectively, the sensing circuit 4304 and control circuit may perform control actions that are not specifically associated with the hybrid converter modules.

The sensing circuit 4304 may take in various signals needed to implement control strategies. This may include AC voltage signals from the AC grid and/or load, such as line-to-line and/or line-to-neutral voltages. The sensing circuit 4304 may further include DC voltage signals from battery terminals, voltage signals from the blocks, and current measurements such as the current in arm inductors, the AC load and/or AC source, and/or the DC source. Furthermore, the sensing strategy may include measurements of aggregates of signals, such as the sum or difference of multiple signals. For example, a single current sensor may be used to measure the sum of arm inductor currents in a single leg.

The power conversion system 4300 may include an EMI filter enclosure 4306 that includes electromagnetic interference filtering components. The EMI filter enclosure 4306 may include a simple configuration with capacitors and inductors, which may be configured as differential, common mode, or a combination of both. The EMI filter enclosure 4306 may couple to the AC load and/or AC source via an AC circuit breaker. The EMI filter enclosure 4306 may optionally be accompanied by one or more surge protection circuits, which will substantially reduce the propagation of abnormally high voltages that may originate with the AC load and/or AC source.

The power conversion system 4300 may include multiple connection points labeled ±B1, ±B2, ±B3, and ±B4, which couple to the hybrid converter modules. Some of these block terminals may couple to the positive end of the DC source via a DC breaker, while others couple to the negative end of the DC source. The remaining block terminals may couple to arm inductors within the EMI filter enclosure 4306. The arm inductors may be coupled in pairs to the EMI filter components as shown.

One of ordinary skills in the art will recognize that there are numerous ways to physically implement the controllers within the power conversion system 4300. For example, various elements may be implemented as analog circuits, such as with amplifiers and comparators, or as digital circuits, such as combinatorial logic, microcontrollers, sequential logic, or programmable logic. Combinations of analog and digital methods may be used. The system may be modified or augmented to include commonly known elements to improve performance or robustness, such as filters, limiters, anti-windup integrators, and other methods commonly known in the art.

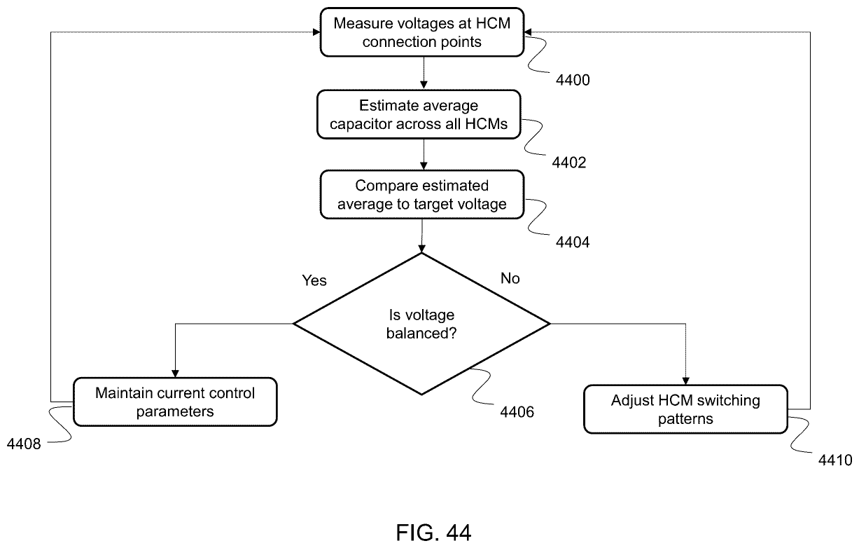

FIG. 44 illustrates a flowchart of an exemplary process for measuring and adjusting voltages in a hybrid converter module system. At step 4400, voltages are measured at HCM connection points. For example, the voltage sensor 728 in FIG. 31 may measure voltages at the connection points between the hybrid converter modules 3106 and the power combiner unit 3108.

At step 4402, an average capacitor voltage is estimated (e.g., and/or measured) across all HCMs. For example, the controller 3110 within the power combiner unit 3108 in FIG. 31 may estimate (e.g., and/or measured) the average capacitor voltage across all hybrid converter modules 3106 based on the measured voltages.

At step 4404, the estimated average voltage is compared to a target voltage. For example, the controller 3110 in FIG. 31 may compare the estimated average capacitor voltage to a predetermined target voltage for optimal system performance.

At decision step 4406, a determination is made whether the voltage is balanced. For example, the controller 3110 in FIG. 31 may evaluate if the estimated average capacitor voltage falls within an acceptable range of the target voltage.

If the voltage is balanced, the process moves to step 4408, where current control parameters are maintained. For example, the controller 3110 in FIG. 31 may maintain the current switching patterns and duty cycles for the hybrid converter modules 3106.

If the voltage is not balanced, the process proceeds to step 4410, where HCM switching patterns are adjusted. For example, the controller 3110 in FIG. 31 may modify the switching patterns or duty cycles of the hybrid converter modules 3106 to bring the average capacitor voltage closer to the target voltage.

After steps 4408 or 4410, the process returns to step 4400 to continue monitoring and adjusting voltages. For example, the voltage sensor 728 and controller 3110 in FIG. 31 may continuously cycle through these steps to maintain balanced voltages across the hybrid converter modules 3106 in the modular energy conversion system 3100.

FIG. 45 illustrates exemplary sample waveforms 4500 of voltage traces in a modular energy conversion system. As shown in FIG. 45, sample waveforms 4500 are generated from a simulation of a modular energy conversion system. The waveforms include multiple voltage traces labeled V(X1·VIN), V(X2·VIN), V(X3·VIN), and V(X4 VIN), which represent the voltages at the pulse ports for four hybrid converter modules (HCMs).

In this simulation, the voltage V(VO) is commanded to produce 120 V (rms). A module capacitance of 3 mF (3000 microfarads) is used for each HCM, and a switching frequency of 4 kHz is employed for the pulse port outputs. The center points of the pulses from the four HCMs are intentionally staggered by one-quarter of a switching cycle to reduce harmonic content in the output waveform. As clearly visible in the figure, each HCM operates with a different duty cycle, with the pulse widths varying between the four traces. Each duty cycle is controlled simultaneously to produce the VO waveform that delivers a 50 Hz fundamental at approximately 120 V (rms).

The duty cycles of each pulse port are controlled simultaneously to achieve multiple objectives: producing the V(VO) waveform that delivers a fundamental frequency component at the desired voltage level, regulating the voltages of the capacitors in each HCM, and maintaining balanced operation across all modules.

In the simulation represented by sample waveforms 4500, the solar panels are effectively disabled or disconnected, so the waveforms represent only power flow to and from the batteries. The bipolar batteries used in this simulation are each rated at 200 V. Various control methods available in scientific literature for modular multilevel converters can be applied to achieve these control objectives.

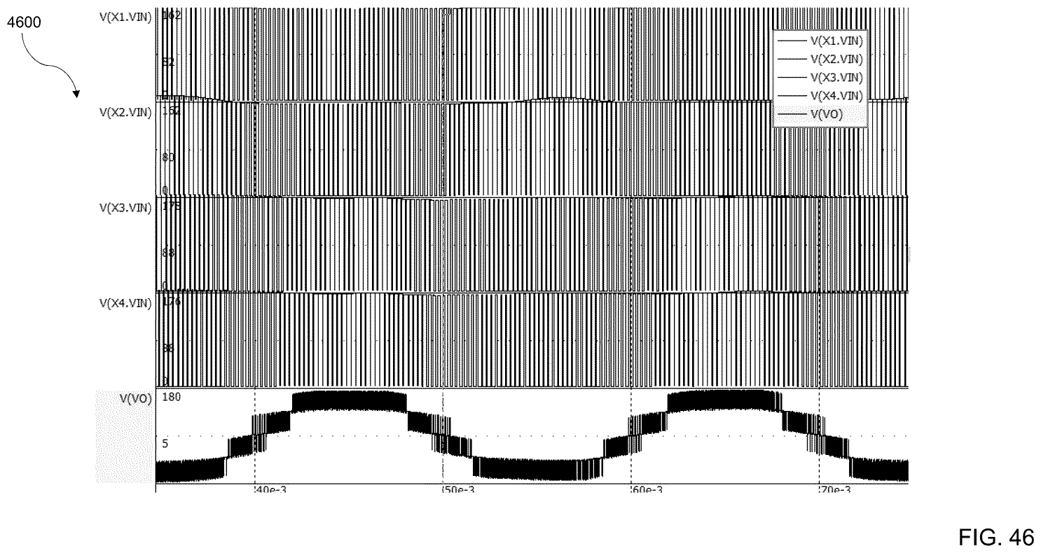

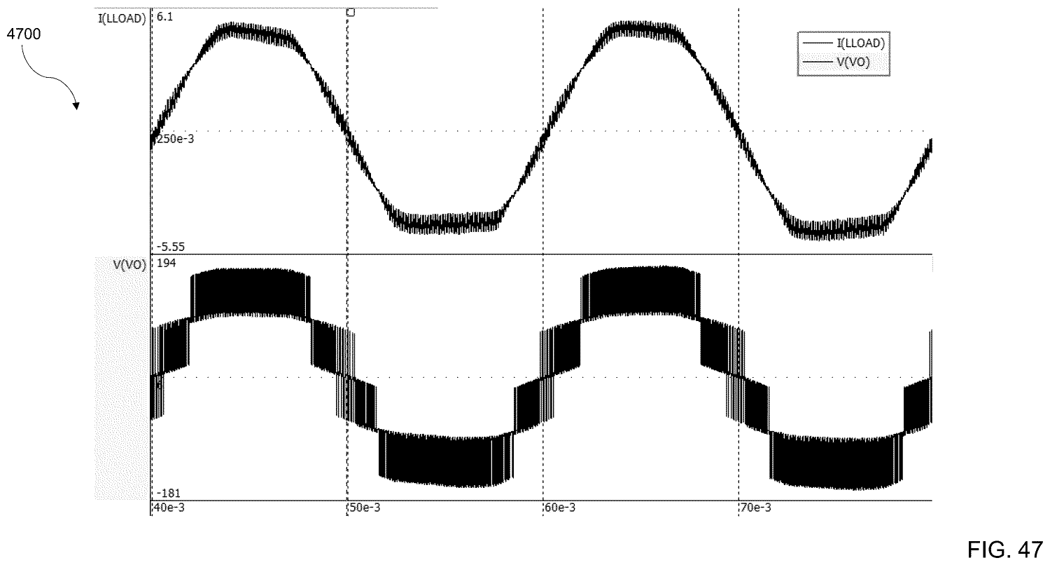

FIG. 46 illustrates additional exemplary sample waveforms 4600 of voltage traces in a modular energy conversion system. FIG. 47 illustrates sample waveforms 4600 from a simulation of the modular energy conversion system. The figure depicts five voltage traces arranged vertically, with four upper traces labeled V(X1·VIN), V(X2·VIN), V(X3·VIN), and V(X4·VIN). These traces represent the output voltages from individual hybrid converter modules. The sample waveforms are displayed on a wider time scale that reveals two complete cycles of the V(VO) waveform. From this expanded view, the approximately sinusoidal shape of the V(VO) waveform becomes apparent, demonstrating how the discrete voltage steps from the individual modules combine to synthesize a waveform that approximates a sine wave.

FIG. 47 illustrates exemplary sample waveforms 4700 of current and voltage measurements in a modular energy conversion system. FIG. 47 depicts two waveform traces plotted over time. The voltage waveform V(VO) is generated by the coordinated switching of the hybrid converter modules, creating multiple discrete voltage levels that approximate a sinusoidal shape. The current waveform I(LOAD) flows through a load inductor LLOAD, which serves as a filter inductance in series with the utility grid and has a value of 2 mH. The current through LLOAD is substantially sinusoidal except for some harmonic distortion. This harmonic distortion can be reduced or substantially eliminated using current feedback, which can be accomplished using numerous techniques described herein as well as from the published literature on inverters. A further reduction in distortion can be obtained by using more HCMs in each arm. At the current level shown in the waveforms 4700, approximately 500 W of power is being delivered to the AC load.

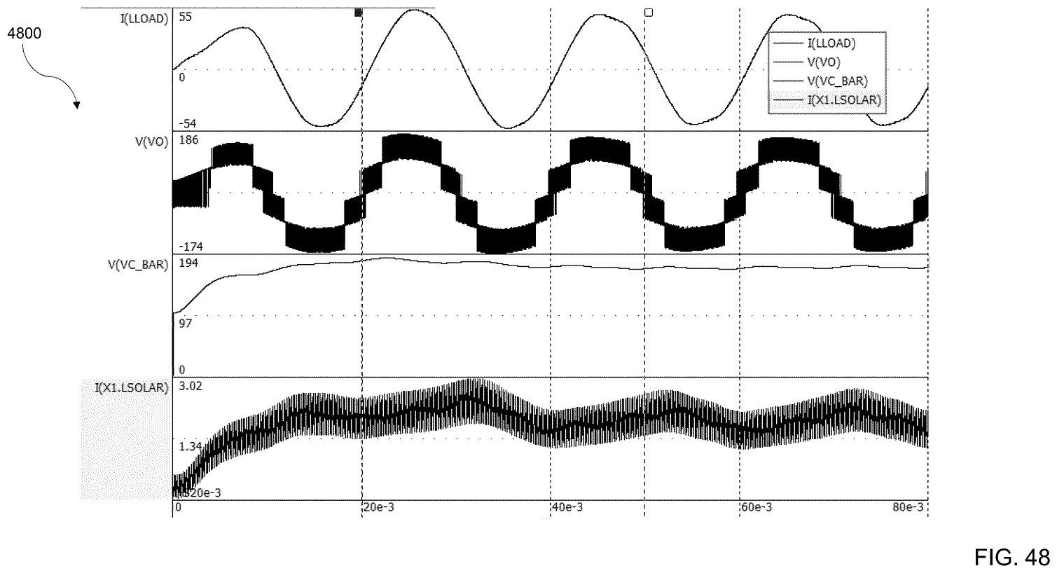

FIG. 48 illustrates exemplary sample waveforms 4800 of multiple electrical parameters in a modular energy conversion system. The waveforms show the system operating at approximately 5 kW output power with solar panels enabled for each of the four hybrid converter modules (HCMs). The sample waveforms 4800 display startup behavior and several operational cycles. The top trace labeled I(LOAD) shows a sinusoidal current waveform, representing the output current delivered to the load. The second trace labeled V(VO) displays a stepped voltage waveform, demonstrating the multilevel voltage synthesis capability of the system. The third trace labeled V(VC_BAR) shows the average capacitor voltage of all four Cmodule capacitors, which settles very near the target value of 175 V, confirming proper voltage regulation across the modules. The bottom trace labeled I(X1·LSOLAR) exhibits the solar panel current of the first HCM, which settles around 1.67 A based on its current operating condition (approximately 28 W from the solar panel). The sample waveforms 4800 illustrate power delivery to the main service panel jointly from the solar panels and batteries. Notably, the system uses only 3 mF of module capacitance (Cmodule) for each HCM, with each HCM processing approximately 1.25 kW of power (5 kW/4). This represents a substantial reduction in capacitance compared to conventional microinverters, which typically use 10 mF or more of bulk capacitance for power ratings of only 400 W.

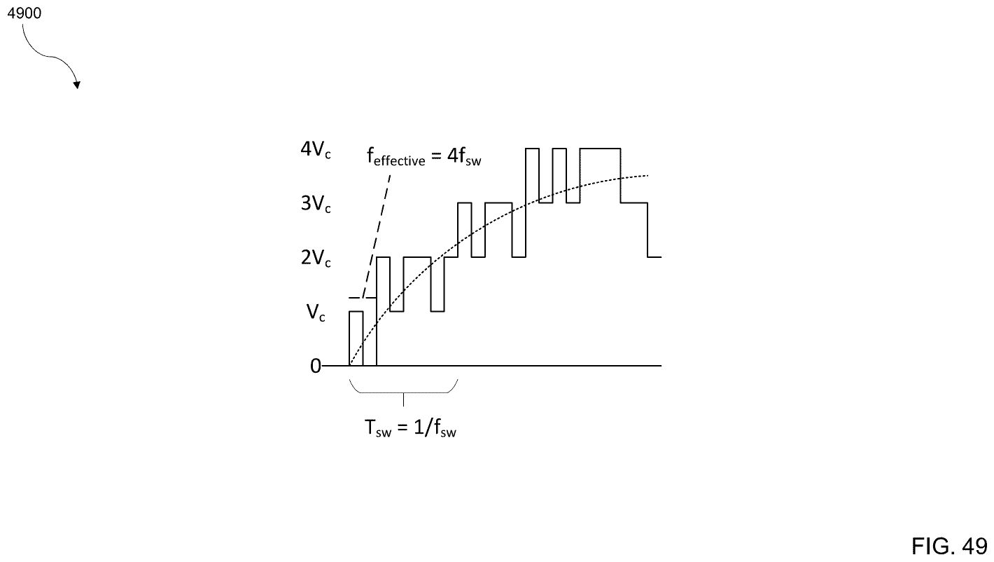

FIG. 49 illustrates an exemplary stair-step voltage waveform 4900 in a modular energy conversion system. As depicted in FIG. 49, the switches of each HCM are independently controlled to produce an aggregate voltage (Vm1+Vm2+Vm3+Vm4) having five different levels. The switches are controlled to produce an aggregate voltage approximately equal to the dashed curve shown in the figure. While the voltages of all four capacitors are considered to be equal in this representation, in practical implementations they will generally differ slightly due to control transients, component tolerances, and other practical considerations. The stair-step waveform can be filtered to more precisely approximate a desired smooth waveform, such as that shown by the dashed line. It is noteworthy that while each HCM switches with a frequency of fsw, the aggregate waveform experiences an “effective” switching frequency of 4 fsw, which represents a significant advantage as higher frequencies are easier to filter while maintaining the efficiency benefits of lower switching frequency operation at the individual HCM level.

FIG. 50 illustrates exemplary sample waveforms 5000 of voltage and current in a modular energy conversion system. The upper trace shows the voltage V(VOUT) displayed in green, exhibiting a stepped or quantized waveform pattern. This stepped voltage waveform demonstrates the multilevel voltage synthesis capability of the system, where discrete voltage levels are combined to approximate a sinusoidal waveform. The lower trace shows the current I(LOAD) displayed in black, which exhibits a smoother sinusoidal pattern oscillating between similar positive and negative values. These waveforms represent simulation results based on a two-leg embodiment of the system. In this simulation, a total of 8 HCMs are used to deliver approximately 16 A at 50 Hz to a 120 V AC power grid. The configuration results in nine distinct voltage levels and, with an HCM switching frequency of 4 kHz, produces an aggregate voltage having an effective frequency of 32 kHz. This multilevel approach enables efficient power conversion while maintaining high power quality through the stepped voltage synthesis technique. The minimal current distortion observed in the simulation results may be attributed to the implemented current feedback techniques and the system reaching steady-state operation.

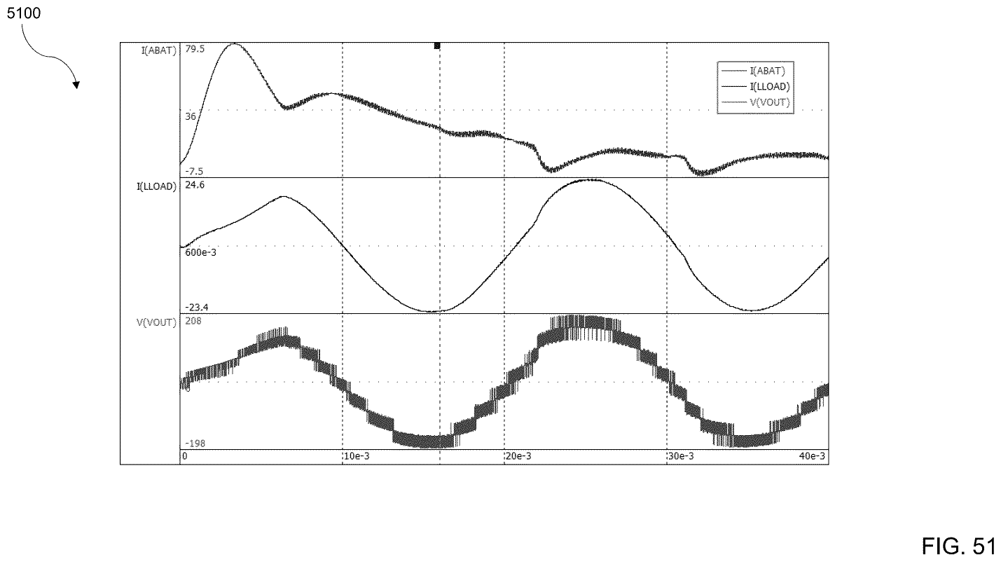

FIG. 51 illustrates exemplary sample waveforms 5100 of multiple electrical parameters in a modular energy conversion system. As shown in FIG. 51, sample waveforms 5100 from a simulation study represent the functioning of one embodiment of the modular energy conversion system. The waveforms show a two-leg system having two HCMs per block, programmed to produce an approximately 120 V (rms) voltage waveform across a passive load configured to consume approximately 1.92 KW. The system is powered by a 200 V battery, with the HCMs. Each HCM utilizes a 3300 microfarad capacitor, with a commanded capacitor voltage of 100 V for each unit.

The sample waveforms 5100 depict the startup transient of the system, with the battery current I(ABAT) shown in the top trace, the AC load current I(LOAD) displayed in the middle trace, and the AC load voltage V(VOUT) (measured between the leg connection points) shown in the bottom trace.

As observed in the waveforms, after 1-2 cycles at 50 Hz, both the voltage and current begin to appear substantially sinusoidal. The voltage waveform exhibits characteristic stairstep features due to the nine levels of control available in this configuration of the system. The voltage's fundamental component is approximately 120 V. The current waveform appears more smoothly sinusoidal due to the filtering effect of the arm inductors and load inductance, with minimal ripple visible at the scale shown in the figure.

It is worth noting that with the FIG. 7 form of the HCM, the capacitor voltage for each HCM is preferably at least the battery voltage divided by N, which is 100 V in this case. This ensures that the voltage applied to the leg connection point can be lowered below or raised above 0 V by the HCMs in the respective blocks.

In some implementations, the capacitor voltages in the HCMs may be selected based on various system design parameters to optimize performance. For instance, factors such as the battery voltage, target AC output voltage, inductance values, and the choice between half-bridge or full-bridge configurations in the HCMs may influence the ideal capacitor voltage settings. By carefully considering these parameters, system designers may tailor the capacitor voltages to achieve desired voltage ranges, power handling capabilities, and overall system efficiency.

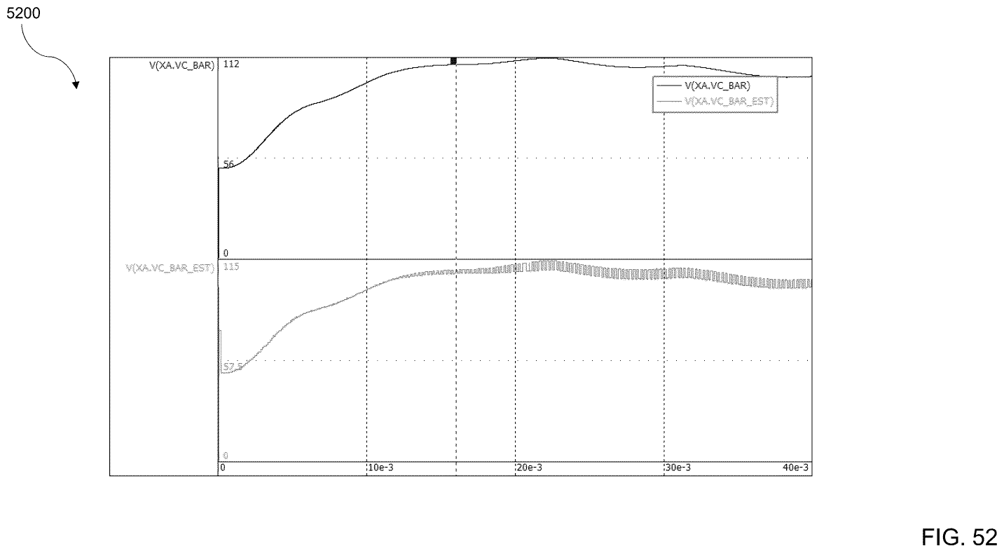

FIG. 52 illustrates exemplary sample waveforms 5200 of voltage measurements in a modular energy conversion system. As shown in FIG. 52, both the average capacitor voltage and the estimated value are approaching the 100 V command value. The estimated voltage trace exhibits a jagged shape due to the absence of a low-pass filter in this illustrative case. Despite lacking the low-pass filter, the system operates as intended. It should be noted that the average capacitor voltage shown in the upper trace is a value computed in simulation and would not actually need to be measured in practical implementations; it is provided for comparison purposes only.

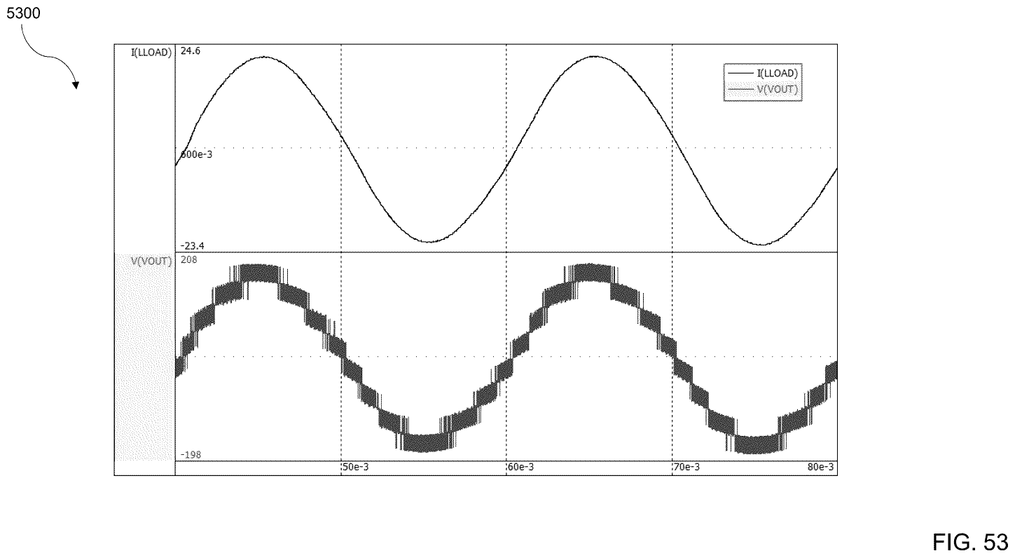

FIG. 53 illustrates exemplary sample waveforms 5300 of current and voltage in a modular energy conversion system. As shown in FIG. 53, additional cycles of the system operating closer to steady state are depicted. As such, these AC voltage and current waveforms more closely resemble the intended sine waves. The purpose of FIG. 53 is also to illustrate transient stability as the system is run farther into steady state, demonstrating how the hybrid converter modules maintain coordinated operation to produce consistent output waveforms over extended operation.

Although various embodiments have been described with reference to the figures, other embodiments are possible.

Although an exemplary system has been described with reference to FIGS. 1-54, other implementations may be deployed in other industrial, scientific, medical, commercial, and/or residential applications.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may include a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as (nominal) batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device. The display device may, for example, include an LED (light-emitting diode) display. In some implementations, a display device may, for example, include a CRT (cathode ray tube). In some implementations, a display device may include, for example, an LCD (liquid crystal display). A display device (e.g., monitor) may, for example, be used for displaying information to the user. Some implementations may, for example, include a keyboard and/or pointing device (e.g., mouse, trackpad, trackball, joystick), such as by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

In an illustrative aspect, a first modular energy conversion system may include a unipolar voltage source. For example, the first modular energy conversion system may include a distributed power converter may include a hybrid converter leg may include a first hybrid converter arm (HCA) and a second HCA. For example, the first HCA, the second HCA, and the unipolar source may be connected to form an electrical circuit. For example, each HCA may include one or more serially connected hybrid converter modules (HCMs), a reference voltage terminal connected to one end of the unipolar voltage source, and an output terminal coupled to a common connection point.

For example, the first modular energy conversion system may include a power combiner unit (PCU) electrically connected to the common connection point, and may include a capacitor voltage sensing circuit. For example, each of the HCMs may be locally connected to an external power source distributedly placed to independently generate a distinct power output to an output port of a corresponding HCM, wherein, at the output terminal, the first HCA and the second HCA each generates an alternating current (AC) power based on the distinct power output generate by each of the serially connected HCMs. For example, the PCU may be physically separated from the HCMs and may be configured to remotely measure an electrical property may include remote sensing of capacitor voltages of the HCMs at the common connection point, such that the PCU adaptively regulate AC power generated at the connection point based on the measured electrical property.

In some embodiments, the first modular energy conversion system may include one or more of the following features:
For example, each HCM may include a DC-DC converter electrically connected to the input port and configured to perform maximum power point tracking for a solar panel connected to the input port. For example, the input port may include a solar port configured to an independent solar panel.
For example, each HCM may include a local controller configured to autonomously regulate an output power of the HCM based on solar input conditions at the input port.
For example, the local controller may be configured to implement an independent maximum power point tracking algorithm.
For example, the capacitor voltage sensing circuit may be configured to detect voltage imbalances between HCMs and trigger compensatory switching adjustments to maintain balanced operation.
For example, the capacitor voltage sensing circuit may be configured to estimate an average capacitor voltage across all HCMs based on measurements of voltages at connection points between the HCMs.
The first modular energy conversion system, for example, may include a second hybrid converter leg having the same structure as the hybrid converter leg, and connected in parallel to the hybrid converter leg and the unipolar voltage source. For example, a second connection point connecting a third HCA and a fourth HCA of the second hybrid converter leg may be electrically coupled to the output terminal. For example, the PCU may adaptively regulate AC power generated at the output terminal based on the measured electrical property at both the hybrid converter leg and the second hybrid converter leg.

In an illustrative aspect, a second modular energy conversion system may include a unipolar voltage source. For example, the second modular energy conversion system may include a distributed power converter may include a hybrid converter leg may include a first hybrid converter arm (HCA) and a second HCA. For example, the first HCA, the second HCA, and the unipolar source may be connected to form an electrical circuit.

For example, each HCA may include a reference voltage terminal connected to one end of the unipolar voltage source. For example, each HCA may include an output terminal coupled to a common connection point.

For example, the second modular energy conversion system may include a power combiner unit (PCU) electrically connected to the common connection point. For example, the first HCA and the second HCA may be configured to receive power from a plurality of external power sources distributedly placed to independently generate an alternating current (AC) power at the output terminal. For example, the PCU may be physically separated from the first HCA and the second HCA, and may be configured to adaptively regulate the AC power based on an electrical property remotely measured at the common connection point.

In some embodiments, the second modular energy conversion system may include one or more of the following features:
For example, each of the first HCA and the second HCA may include one or more serially connected hybrid converter modules (HCMs), and each of the HCMs may be locally connected to one of the plurality of external power sources, each generating a distinct power output such that, at the output terminal, the first HCA and the second HCA each generates the AC power based on the distinct power output generate by each of the serially connected HCMs.
For example, the PCU may include a capacitor voltage sensing circuit, and the electrical property may include capacitor voltages of the HCMs at the common connection point.
For example, the capacitor voltage sensing circuit may be configured to estimate an average capacitor voltage across all HCMs based on measurements of voltages at connection points between the HCMs.
For example, the capacitor voltage sensing circuit may be configured to detect voltage imbalances between HCMs and trigger compensatory switching adjustments to maintain balanced operation.
For example, the capacitor voltage sensing circuit may be configured to estimate an average capacitor voltage across all HCMs based on measurements of voltages at connection points between the HCMs.
For example, the external power source may include a plurality of independent solar panels, and each of the one or more serially connected HCM may include an input port coupled to receive power from one of the plurality of independent solar panels. For example, each of the one or more serially connected HCM may include a local controller configured to autonomously regulate the distinct power output the HCM based on solar power received at the input port.
For example, the local controller may be further configured to a perform maximum power point tracking for the one of the plurality of independent solar panels.
For example, the PCU configured to regulate the AC power based on an independent maximum power point tracking algorithm.
The second modular energy conversion system, for example, may include a second hybrid converter leg having the same structure as the hybrid converter leg, and connected in parallel to the hybrid converter leg and the unipolar voltage source. For example, a second connection point connecting a third HCA and a fourth HCA of the second hybrid converter leg may be electrically coupled to the output terminal. For example, the PCU adaptively regulate AC power generated at the output terminal based on the measured electrical property at both the hybrid converter leg and the second hybrid converter leg.

In an illustrative aspect, a method of operating a modular energy conversion system may include receiving DC power at a plurality of hybrid converter modules (HCMs). For example, each of the plurality of HCMs receives the DC power from a distinct set of one or more solar panels. For example, the method may include connecting output ports of a first subset of HCMs in series to form an upper arm. For example, the method may include connecting output ports of a second subset of HCMs in series to form a lower arm. For example, the method may include connecting a unipolar voltage source to the upper arm and the lower arm. For example, the method may include establishing a connection point between the upper arm and the lower arm. For example, the method may include adaptively regulating controlling, by a power combiner unit (PCU) physically separated from the connection point, an AC power at the connection point as a function of capacitor voltages of each HCM remotely measured by a capacitor voltage sensing circuit of the PCU. For example, the method may include outputting the regulated AC power from the connection point.

In some embodiments, the method may include one or more of the following features:
The method, for example, may include autonomously regulating, by a local controller in each HCM, an output power of the HCM based on power received from the distinct set of one or more solar panels based on an independent maximum power point tracking algorithm.
For example, remotely measuring the capacitor voltages may include estimating an average capacitor voltage across all HCMs based on measurements of voltages at connection points between the HCMs.

In some embodiments, the first modular energy conversion system may be combined with any part or whole of the second modular energy conversion system. In some embodiments, the first modular energy conversion system may be combined any part or whole of with the method. In some embodiments, the second modular energy conversion system may be combined with any part or whole of the first modular energy conversion system. In some embodiments, the second modular energy conversion system may be combined with any part or whole of the method. In some embodiments, the method may be combined with any part or whole of the first modular energy conversion system. In some embodiments, the method may be combined with any part or whole of the second modular energy conversion system.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A modular energy conversion system, comprising:
a unipolar voltage source;
a distributed power converter comprises a hybrid converter leg comprising a first hybrid converter arm (HCA) and a second HCA, wherein:
the first HCA, the second HCA, and the unipolar source are connected to form an electrical circuit; and,
each HCA comprises one or more serially connected hybrid converter modules (HCMs), a reference voltage terminal connected to one end of the unipolar voltage source, and an output terminal coupled to a common connection point; and,
a power combiner unit (PCU) electrically connected to the common connection point, and comprises a capacitor voltage sensing circuit, wherein:
each of the HCMs are locally connected to an external power source distributedly placed to independently generate a distinct power output to an output port of a corresponding HCM, wherein, at the output terminal, the first HCA and the second HCA each generates an alternating current (AC) power based on the distinct power output generate by each of the serially connected HCMs; and
the PCU is physically separated from the HCMs and is configured to remotely measure an electrical property comprising remote sensing of capacitor voltages of the HCMs at the common connection point, such that the PCU adaptively regulate AC power generated at the connection point based on the measured electrical property.

2. The modular energy conversion system of claim 1, wherein each HCM comprises a DC-DC converter electrically connected to the input port and configured to perform maximum power point tracking for a solar panel connected to the input port, wherein the input port comprises a solar port configured to an independent solar panel.

3. The modular energy conversion system of claim 2, wherein each HCM further comprises a local controller configured to autonomously regulate an output power of the HCM based on solar input conditions at the input port.

4. The modular energy conversion system of claim 3, wherein the local controller is configured to implement an independent maximum power point tracking algorithm.

5. The modular energy conversion system of claim 1, wherein the capacitor voltage sensing circuit is configured to detect voltage imbalances between HCMs and trigger compensatory switching adjustments to maintain balanced operation.

6. The modular energy conversion system of claim 5, wherein the capacitor voltage sensing circuit is configured to estimate an average capacitor voltage across all HCMs based on measurements of voltages at connection points between the HCMs.

7. The modular energy conversion system of claim 1, further comprises a second hybrid converter leg having the same structure as the hybrid converter leg, and connected in parallel to the hybrid converter leg and the unipolar voltage source, wherein:
a second connection point connecting a third HCA and a fourth HCA of the second hybrid converter leg is electrically coupled to the output terminal; and,
the PCU adaptively regulate AC power generated at the output terminal based on the measured electrical property at both the hybrid converter leg and the second hybrid converter leg.

8. A modular energy conversion system, comprising:
a unipolar voltage source;
a distributed power converter comprises a hybrid converter leg comprising a first hybrid converter arm (HCA) and a second HCA, wherein:
the first HCA, the second HCA, and the unipolar source are connected to form an electrical circuit; and,
each HCA comprises:
a reference voltage terminal connected to one end of the unipolar voltage source; and,
an output terminal coupled to a common connection point; and,
a power combiner unit (PCU) electrically connected to the common connection point, wherein:
the first HCA and the second HCA are configured to receive power from a plurality of external power sources distributedly placed to independently generate an alternating current (AC) power at the output terminal; and
the PCU is physically separated from the first HCA and the second HCA, and is configured to adaptively regulate the AC power based on an electrical property remotely measured at the common connection point.

9. The modular energy conversion system of claim 8, wherein each of the first HCA and the second HCA comprises one or more serially connected hybrid converter modules (HCMs), and each of the HCMs are locally connected to one of the plurality of external power sources, each generating a distinct power output such that, at the output terminal, the first HCA and the second HCA each generates the AC power based on the distinct power output generate by each of the serially connected HCMs

10. The modular energy conversion system of claim 9, wherein the PCU comprises a capacitor voltage sensing circuit, and the electrical property comprises capacitor voltages of the HCMs at the common connection point.

11. The modular energy conversion system of claim 10, wherein the capacitor voltage sensing circuit is configured to estimate an average capacitor voltage across all HCMs based on measurements of voltages at connection points between the HCMs.

12. The modular energy conversion system of claim 10, wherein the capacitor voltage sensing circuit is configured to detect voltage imbalances between HCMs and trigger compensatory switching adjustments to maintain balanced operation.

13. The modular energy conversion system of claim 12, wherein the capacitor voltage sensing circuit is configured to estimate an average capacitor voltage across all HCMs based on measurements of voltages at connection points between the HCMs.

14. The modular energy conversion system of claim 9, wherein the external power source comprise a plurality of independent solar panels, and each of the one or more serially connected HCM comprises:
an input port coupled to receive power from one of the plurality of independent solar panels; and,
a local controller configured to autonomously regulate the distinct power output the HCM based on solar power received at the input port.

15. The modular energy conversion system of claim 14, wherein the local controller is further configured to a perform maximum power point tracking for the one of the plurality of independent solar panels.

16. The modular energy conversion system of claim 15, wherein the PCU configured to regulate the AC power based on an independent maximum power point tracking algorithm.

17. The modular energy conversion system of claim 8, further comprises a second hybrid converter leg having the same structure as the hybrid converter leg, and connected in parallel to the hybrid converter leg and the unipolar voltage source, wherein:
a second connection point connecting a third HCA and a fourth HCA of the second hybrid converter leg is electrically coupled to the output terminal; and,
the PCU adaptively regulate AC power generated at the output terminal based on the measured electrical property at both the hybrid converter leg and the second hybrid converter leg.

18. A method of operating a modular energy conversion system, the method comprises:
receiving DC power at a plurality of hybrid converter modules (HCMs), wherein each of the plurality of HCMs receives the DC power from a distinct set of one or more solar panels;
connecting output ports of a first subset of HCMs in series to form an upper arm;
connecting output ports of a second subset of HCMs in series to form a lower arm;
connecting a unipolar voltage source to the upper arm and the lower arm;
establishing a connection point between the upper arm and the lower arm;
adaptively regulating controlling, by a power combiner unit (PCU) physically separated from the connection point, an AC power at the connection point as a function of capacitor voltages of each HCM remotely measured by a capacitor voltage sensing circuit of the PCU; and,
outputting the regulated AC power from the connection point.

19. The method of claim 17, further comprises:
autonomously regulating, by a local controller in each HCM, an output power of the HCM based on power received from the distinct set of one or more solar panels based on an independent maximum power point tracking algorithm.

20. The method of claim 17, wherein remotely measuring the capacitor voltages comprises estimating an average capacitor voltage across all HCMs based on measurements of voltages at connection points between the HCMs.
